(19) United States
(12) Patent Application Publication
(10) Pub. No.: US 2026/0052530 A1
(43) Pub. Date: Feb. 19, 2026

(54) DYNAMIC BANDWIDTH ALLOCATION AND DYNAMIC PRIORITIZATION FOR LOGICAL CHANNELS

(71) Applicant: QUALCOMM Incorporated, San Diego, CA (US)

(72) Inventors: Linhai HE, San Diego, CA (US); Qing LI, Princeton Junction, NJ (US); Hyun Yong LEE, San Diego, CA (US)

(21) Appl. No.: 19/258,310

(22) Filed: Jul. 2, 2025

Related U.S. Application Data
(60) Provisional application No. 63/683,121, filed on Aug. 14, 2024.

(51) Int. Cl. H04W 72/1268; H04L 41/16; H04W 72/0457; H04W 72/566

(52) U.S. Cl. CPC H04W 72/1268; H04L 41/16; H04W 72/0457; H04W 72/566

(57) ABSTRACT

Various aspects of the present disclosure generally relate to wireless communication. In some aspects, a user equipment (UE) may receive a configuration indicating a shared bandwidth allocation. The UE may receive an uplink grant that indicates an uplink resource allocation. The UE may transmit data associated with a logical channel (LCH) in the uplink resource allocation, wherein the data associated with the LCH that is transmitted in the uplink resource allocation occupies at least a portion of the shared bandwidth allocation. Numerous other aspects are described.

### CROSS-REFERENCE TO RELATED APPLICATION

This Patent application claims priority to U.S. Provisional Patent Application No. 63/683,121, filed on Aug. 14, 2024, entitled “DYNAMIC BANDWIDTH ALLOCATION AND DYNAMIC PRIORITIZATION FOR LOGICAL CHANNELS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with dynamic bandwidth allocation and dynamic prioritization for logical channels.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to an apparatus for wireless communication at a user equipment (UE). The apparatus may include one or more memories and one or more processors coupled to the one or more memories. The one or more processors may be configured to receive a configuration indicating a shared bandwidth allocation. The one or more processors may be configured to receive an uplink grant that indicates an uplink resource allocation. The one or more processors may be configured to transmit data associated with a logical channel (LCH) in the uplink resource allocation, wherein the data associated with the LCH that is transmitted in the uplink resource allocation occupies at least a portion of the shared bandwidth allocation.

Some aspects described herein relate to an apparatus for wireless communication at a UE. The apparatus may include one or more memories and one or more processors coupled to the one or more memories. The one or more processors may be configured to receive a configuration that indicates a first priority associated with a first LCH and indicates that the first LCH is allowed to upgrade data to a second LCH associated with a second priority that is higher than first priority. The one or more processors may be configured to receive an uplink grant that indicates an uplink resource allocation. The one or more processors may be configured to transmit data associated with the second LCH in the uplink resource allocation, wherein the data associated with the second LCH that is transmitted in the uplink resource allocation includes data that the first LCH upgraded to the second LCH in accordance with the configuration.

Some aspects described herein relate to an apparatus for wireless communication at a network node. The apparatus may include one or more memories and one or more processors coupled to the one or more memories. The one or more processors may be configured to transmit a configuration indicating a shared bandwidth allocation. The one or more processors may be configured to transmit an uplink grant that indicates an uplink resource allocation. The one or more processors may be configured to receive data associated with an LCH in the uplink resource allocation, wherein the data associated with the LCH that is received in the uplink resource allocation occupies at least a portion of the shared bandwidth allocation.

Some aspects described herein relate to an apparatus for wireless communication at a network node. The apparatus may include one or more memories and one or more processors coupled to the one or more memories. The one or more processors may be configured to transmit a configuration that indicates a first priority associated with a first LCH and indicates that the first LCH is allowed to upgrade data to a second LCH associated with a second priority that is higher than first priority. The one or more processors may be configured to transmit an uplink grant that indicates an uplink resource allocation. The one or more processors may be configured to receive data associated with the second LCH in the uplink resource allocation, wherein the data associated with the second LCH that is received in the uplink resource allocation includes data that the first LCH upgraded to the second LCH in accordance with the configuration.

Some aspects described herein relate to a method of wireless communication performed by a UE. The method may include receiving a configuration indicating a shared bandwidth allocation. The method may include receiving an uplink grant that indicates an uplink resource allocation. The method may include transmitting data associated with an LCH in the uplink resource allocation, wherein the data associated with the LCH that is transmitted in the uplink resource allocation occupies at least a portion of the shared bandwidth allocation.

Some aspects described herein relate to a method of wireless communication performed by a UE. The method may include receiving a configuration that indicates a first priority associated with a first LCH and indicates that the first LCH is allowed to upgrade data to a second LCH associated with a second priority that is higher than first priority. The method may include receiving an uplink grant that indicates an uplink resource allocation. The method may include transmitting data associated with the second LCH in the uplink resource allocation, wherein the data associated with the second LCH that is transmitted in the uplink resource allocation includes data that the first LCH upgraded to the second LCH in accordance with the configuration.

Some aspects described herein relate to a method of wireless communication performed by a network node. The method may include transmitting a configuration indicating a shared bandwidth allocation. The method may include transmitting an uplink grant that indicates an uplink resource allocation. The method may include receiving data associated with an LCH in the uplink resource allocation, wherein the data associated with the LCH that is received in the uplink resource allocation occupies at least a portion of the shared bandwidth allocation.

Some aspects described herein relate to a method of wireless communication performed by a network node. The method may include transmitting a configuration that indicates a first priority associated with a first LCH and indicates that the first LCH is allowed to upgrade data to a second LCH associated with a second priority that is higher than first priority. The method may include transmitting an uplink grant that indicates an uplink resource allocation. The method may include receiving data associated with the second LCH in the uplink resource allocation, wherein the data associated with the second LCH that is received in the uplink resource allocation includes data that the first LCH upgraded to the second LCH in accordance with the configuration.

Some aspects described herein relate to a non-transitory computer-readable medium that stores a set of instructions for wireless communication by a UE. The set of instructions, when executed by one or more processors of the UE, may cause the UE to receive a configuration indicating a shared bandwidth allocation. The set of instructions, when executed by one or more processors of the UE, may cause the UE to receive an uplink grant that indicates an uplink resource allocation. The set of instructions, when executed by one or more processors of the UE, may cause the UE to transmit data associated with an LCH in the uplink resource allocation, wherein the data associated with the LCH that is transmitted in the uplink resource allocation occupies at least a portion of the shared bandwidth allocation.

Some aspects described herein relate to a non-transitory computer-readable medium that stores a set of instructions for wireless communication by a one or more instructions that, when executed by one or more processors of an UE. The set of instructions, when executed by one or more processors of the one or more instructions that, when executed by one or more processors of an UE, may cause the one or more instructions that, when executed by one or more processors of an UE to receive a configuration that indicates a first priority associated with a first LCH and indicates that the first LCH is allowed to upgrade data to a second LCH associated with a second priority that is higher than first priority. The set of instructions, when executed by one or more processors of the one or more instructions that, when executed by one or more processors of an UE, may cause the one or more instructions that, when executed by one or more processors of an UE to receive an uplink grant that indicates an uplink resource allocation. The set of instructions, when executed by one or more processors of the one or more instructions that, when executed by one or more processors of an UE, may cause the one or more instructions that, when executed by one or more processors of an UE to transmit data associated with the second LCH in the uplink resource allocation, wherein the data associated with the second LCH that is transmitted in the uplink resource allocation includes data that the first LCH upgraded to the second LCH in accordance with the configuration.

Some aspects described herein relate to a non-transitory computer-readable medium that stores a set of instructions for wireless communication by a network node. The set of instructions, when executed by one or more processors of the network node, may cause the network node to transmit a configuration indicating a shared bandwidth allocation. The set of instructions, when executed by one or more processors of the network node, may cause the network node to transmit an uplink grant that indicates an uplink resource allocation. The set of instructions, when executed by one or more processors of the network node, may cause the network node to receive data associated with an LCH in the uplink resource allocation, wherein the data associated with the LCH that is received in the uplink resource allocation occupies at least a portion of the shared bandwidth allocation.

Some aspects described herein relate to a non-transitory computer-readable medium that stores a set of instructions for wireless communication by a network node. The set of instructions, when executed by one or more processors of the network node, may cause the network node to transmit a configuration that indicates a first priority associated with a first LCH and indicates that the first LCH is allowed to upgrade data to a second LCH associated with a second priority that is higher than first priority. The set of instructions, when executed by one or more processors of the network node, may cause the network node to transmit an uplink grant that indicates an uplink resource allocation. The set of instructions, when executed by one or more processors of the network node, may cause the network node to receive data associated with the second LCH in the uplink resource allocation, wherein the data associated with the second LCH that is received in the uplink resource allocation includes data that the first LCH upgraded to the second LCH in accordance with the configuration.

Some aspects described herein relate to an apparatus for wireless communication. The apparatus may include means for receiving a configuration indicating a shared bandwidth allocation. The apparatus may include means for receiving an uplink grant that indicates an uplink resource allocation. The apparatus may include means for transmitting data associated with an LCH in the uplink resource allocation, wherein the data associated with the LCH that is transmitted in the uplink resource allocation occupies at least a portion of the shared bandwidth allocation.

Some aspects described herein relate to an apparatus for wireless communication. The apparatus may include means for receiving a configuration that indicates a first priority associated with a first LCH and indicates that the first LCH is allowed to upgrade data to a second LCH associated with a second priority that is higher than first priority. The apparatus may include means for receiving an uplink grant that indicates an uplink resource allocation. The apparatus may include means for transmitting data associated with the second LCH in the uplink resource allocation, wherein the data associated with the second LCH that is transmitted in the uplink resource allocation includes data that the first LCH upgraded to the second LCH in accordance with the configuration.

Some aspects described herein relate to an apparatus for wireless communication. The apparatus may include means for transmitting a configuration indicating a shared bandwidth allocation. The apparatus may include means for transmitting an uplink grant that indicates an uplink resource allocation. The apparatus may include means for receiving data associated with an LCH in the uplink resource allocation, wherein the data associated with the LCH that is received in the uplink resource allocation occupies at least a portion of the shared bandwidth allocation.

Some aspects described herein relate to an apparatus for wireless communication. The apparatus may include means for transmitting a configuration that indicates a first priority associated with a first LCH and indicates that the first LCH is allowed to upgrade data to a second LCH associated with a second priority that is higher than first priority. The apparatus may include means for transmitting an uplink grant that indicates an uplink resource allocation. The apparatus may include means for receiving data associated with the second LCH in the uplink resource allocation, wherein the data associated with the second LCH that is received in the uplink resource allocation includes data that the first LCH upgraded to the second LCH in accordance with the configuration.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 is a diagram illustrating an example architecture of a functional framework for radio access network intelligence enabled by data collection, in accordance with the present disclosure.

FIG. 5 is a diagram illustrating an example of a user plane protocol stack and a control plane protocol stack for a network node and a core network in communication with a UE, in accordance with the present disclosure.

FIG. 6 is a diagram illustrating an example of a mapping among uplink LCHs, transport channels, and physical channels, in accordance with the present disclosure.

FIG. 7 is a diagram illustrating an example associated with LCH prioritization, in accordance with the present disclosure.

FIGS. 8A-8B are diagrams illustrating an example associated with dynamic bandwidth allocation and dynamic prioritization for LCHs, in accordance with the present disclosure.

FIGS. 9-10 are diagrams illustrating example processes performed, for example, at a UE or an apparatus of a UE, in accordance with the present disclosure.

FIGS. 11-12 are diagrams illustrating example processes performed, for example, at a network node or an apparatus of a network node, in accordance with the present disclosure.

FIGS. 13-14 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In a wireless network, a user equipment (UE) and a network node may each implement one or more protocol stacks (e.g., a user plane protocol stack and a control plane protocol stack) that include various protocol layers, such as a physical (PHY) layer, a medium access control (MAC) layer, and a radio link control (RLC) layer, among other examples. Information flows between different protocol layers, known as channels, may be used to segregate and transport different data types across different layers. Accordingly, the channels may provide interfaces between layers within the one or more protocol stacks and enable an orderly and defined data segmentation. For example, logical channels (LCHs) carry user data and signaling messages between the RLC layer and the MAC layer, transport channels carry user data and signaling messages between the MAC layer and the PHY layer, and physical channels carry user data and signaling messages between the UE and the network node. For example, in an uplink direction, uplink LCHs include a common control channel (CCCH) used to carry control information for multiple UEs, a dedicated control channel (DCCH) dedicated to carrying control information for a particular UE, and a dedicated traffic channel (DTCH) dedicated to carrying traffic for a particular UE, and uplink transport channels include an uplink shared channel (UL-SCH) that is used to carry uplink data and shared among the CCCH, DCCH, DTCH. Accordingly, in the uplink direction, the MAC layer performs an LCH prioritization procedure to control the manner in which UL-SCH resources are shared among different LCHs.

For example, when a UE is configured with multiple LCHs that share UL-SCH resources, a MAC layer at the UE may prioritize data from the LCHs according to respective LCH configurations that a network node sends or otherwise provides for the multiple LCHs. For example, the LCH configurations may be provided in one or more radio resource control (RRC) messages, where the parameters associated with each LCH configuration may include a priority (e.g., an integer from 1 to 16 or another suitable value, where 1 corresponds to a highest priority and 16 corresponds to a lowest priority), a prioritized bit rate (PBR) (e.g., a value in kilobytes per second (kBps)), and a bucket size duration (BSD) (e.g., a value in milliseconds). The PBR and the BSD associated with an LCH may parameterize a leaky bucket regulator associated with the LCH, which the MAC layer may use together with the configured priorities to schedule data associated with different LCHs according to a fair priority queuing policy. For example, each LCH is associated with a scheduling eligibility state variable, Bj, which is initialized to zero when the LCH is established. The state variable associated with each LCH is periodically updated (e.g., prior to each LCH prioritization) according to Bj=Bj+PBR×T, where T is a duration or time period since the value of Bj was most recently updated. If Bj has a value that exceeds a bucket size defined as PBR×BSD, the value of Bj is rounded down to the bucket size value.

Accordingly, when an uplink grant is available, the UE initially identifies one or more eligible LCHs (e.g., LCHs that have uplink data and Bj value greater than 0), and starts scheduling data from eligible LCHs according to a descending priority (e.g., from a highest priority to a lowest priority). For example, when scheduling data from an eligible LCH, the selected LCH is allocated enough resources to achieve the PBR associated with the LCH (e.g., a transmit buffer associated with the LCH is emptied by at least the value of Bj), and the state variable Bj for the LCH is then updated by subtracting the size of the scheduled data. If the selected LCH has a PBR with an infinite value, the transmit buffer associated with the LCH is emptied completely before serving any other LCH. In cases where the uplink grant has spare radio resources remaining after all eligible LCHs with a Bj value greater than 0 have been scheduled, the UE then schedules data from all LCHs according to a strict priority without regard to the Bj value (e.g., not limited to eligible LCHs only). In this way, the LCH prioritization may maximize throughput and provide relative delay performance across various LCHs that share UL-SCH resources.

However, although the LCH prioritization provides acceptable performance for elastic traffic that does not have hard delay requirements, the LCH prioritization procedure poses challenges for delay-sensitive traffic that tends to arrive in bursts, such as extended reality (XR) traffic. For example, when data associated with an LCH is scheduled using an LCH prioritization procedure based on a leaky bucket regulator, there is a tradeoff between latency and uplink capacity. For example, when an uplink traffic burst arrives in a buffer associated with an LCH that has a tight or strict latency requirement, the UE needs to have enough bandwidth to finish sending the entire uplink traffic burst within the required delay budget (e.g., where the burst size divided by the delay requirement is the required bandwidth to meet the delay budget). In other words, a network node may need to allocate the LCH extra bandwidth (e.g., using a high PBR value associated with a maximum uplink data burst size) in order to meet the delay requirement associated with the LCH. Accordingly, in cases where the network node allocates bandwidth according to a maximum burst size, the allocated bandwidth may exceed an average data rate, which may result in the allocated bandwidth not being fully utilized because different uplink traffic bursts may have different sizes (e.g., for any uplink traffic bursts that are less than the maximum burst size). As a result, when extra bandwidth is allocated to an LCH to meet a latency requirement, uplink capacity may be utilized less efficiently because unused bandwidth allocated to an LCH cannot be used by other LCHs due to a hard partition among LCHs.

Various aspects described herein generally relate to dynamic bandwidth allocation and/or dynamic prioritization for LCHs, to better balance tradeoffs between latency and uplink capacity. Some aspects more specifically relate to a network node configuring a shared bandwidth allocation that may be used by multiple LCHs (e.g., all LCHs configured for a UE, or a set of LCHs in an LCH scheduling group). In some aspects, the shared bandwidth allocation may be configured as a leaky bucket regulator (e.g., a virtual LCH) associated with a PBR and BSD that controls a size of the bandwidth allocation shared with other LCHs. For example, the shared bandwidth allocation available at a particular time may include T bandwidth tokens that are generated at a rate associated with the PBR, where each bandwidth token corresponds to an amount of bandwidth (e.g., a number of bytes) and the T bandwidth tokens have a maximum total size of PBR×BSD. Alternatively, the shared bandwidth allocation may be defined according to a sliding window of bandwidth tokens, where a number of bandwidth tokens that can be used in a sliding time window may be limited to a maximum value. In this way, an LCH may utilize all or a portion of the shared bandwidth allocation (e.g., up to T bandwidth tokens, or up to the maximum number of bandwidth tokens in the sliding time window) in order to obtain more instantaneous bandwidth to reduce latency and/or meet a delay requirement. Furthermore, the shared bandwidth allocation can be dynamically shared among different LCHs, which may lead to more efficient utilization of uplink capacity.

Additionally, or alternatively, in some aspects, a network node may provide an LCH configuration that allows an LCH to upgrade data associated with the LCH to another LCH with a higher priority. For example, in some aspects, the amount of data that the LCH can upgrade to a higher priority may be defined according to a leaky bucket regulator parameterized by a PBR value and a BSD value, or according to a sliding time window, in a similar manner as the shared bandwidth allocation described above. In this way, an LCH may upgrade an amount of data to another LCH with a higher priority (e.g., an amount of data up to a size associated with a total number of bandwidth tokens in the leaky bucket regulator, or up to a size of the maximum number of bandwidth tokens that are available in the sliding time window) in order to obtain more instantaneous bandwidth to reduce latency and/or meet a delay requirement. Furthermore, data can be dynamically upgraded to the LCH with the higher priority only when needed to reduce latency and/or meet a delay requirement, or when the LCH with the higher priority does not have enough buffered data to fill a bandwidth allocation, which may lead to more efficient utilization of uplink capacity (e.g., by utilizing the full bandwidth allocated to the LCH with the higher priority).

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, XR and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

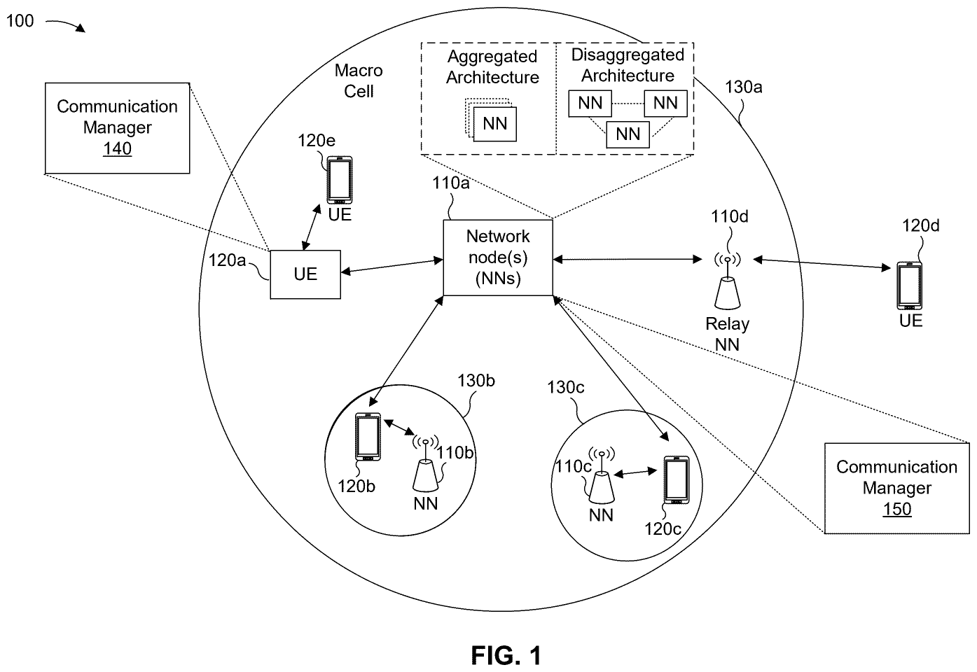

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as RRC functions, packet data convergence protocol (PDCP) functions, and/or service data adaptation protocol (SDAP) functions, among other examples. A DU may host one or more of an RLC layer, a MAC layer, and/or one or more higher PHY layers depending, at least in part, on a functional split, such as a functional split defined by the 3GPP. In some examples, a DU also may host one or more lower PHY layer functions, such as a fast Fourier transform (FFT), an inverse FFT (IFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive a configuration indicating a shared bandwidth allocation; receive an uplink grant that indicates an uplink resource allocation; and transmit data associated with an LCH in the uplink resource allocation, wherein the data associated with the LCH that is transmitted in the uplink resource allocation occupies at least a portion of the shared bandwidth allocation. Additionally, or alternatively, the UE 120 may include a communication manager 140. As described in more detail elsewhere herein, the communication manager 140 may receive a configuration that indicates a first priority associated with a first LCH and indicates that the first LCH is allowed to upgrade data to a second LCH associated with a second priority that is higher than first priority; receive an uplink grant that indicates an uplink resource allocation; and transmit data associated with the second LCH in the uplink resource allocation, wherein the data associated with the second LCH that is transmitted in the uplink resource allocation includes data that the first LCH upgraded to the second LCH in accordance with the configuration. Additionally, or alternatively, the communication manager 140 may perform one or more other operations described herein.

In some aspects, the network node 110 may include a communication manager 150. As described in more detail elsewhere herein, the communication manager 150 may transmit a configuration indicating a shared bandwidth allocation; transmit an uplink grant that indicates an uplink resource allocation; and receive data associated with an LCH in the uplink resource allocation, wherein the data associated with the LCH that is received in the uplink resource allocation occupies at least a portion of the shared bandwidth allocation. Additionally, or alternatively, the network node 110 may include a communication manager 150. As described in more detail elsewhere herein, the communication manager 150 may transmit a configuration that indicates a first priority associated with a first LCH and indicates that the first LCH is allowed to upgrade data to a second LCH associated with a second priority that is higher than first priority; transmit an uplink grant that indicates an uplink resource allocation; and receive data associated with the second LCH in the uplink resource allocation, wherein the data associated with the second LCH that is received in the uplink resource allocation includes data that the first LCH upgraded to the second LCH in accordance with the configuration. Additionally, or alternatively, the communication manager 150 may perform one or more other operations described herein.

As indicated above, FIG. 1 is provided as an example. Other examples may differ from what is described with regard to FIG. 1.

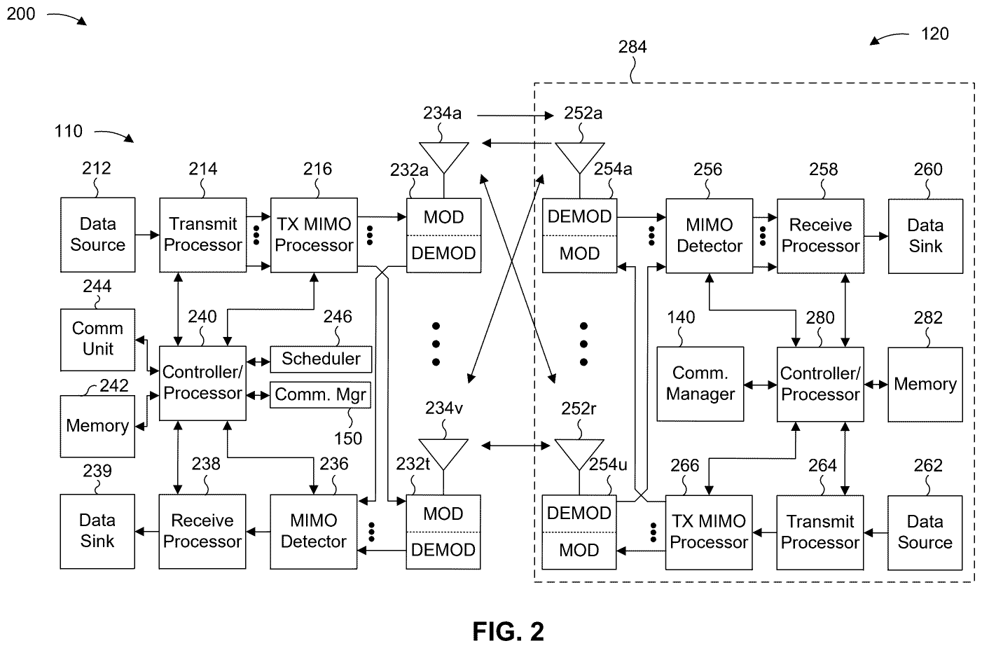

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

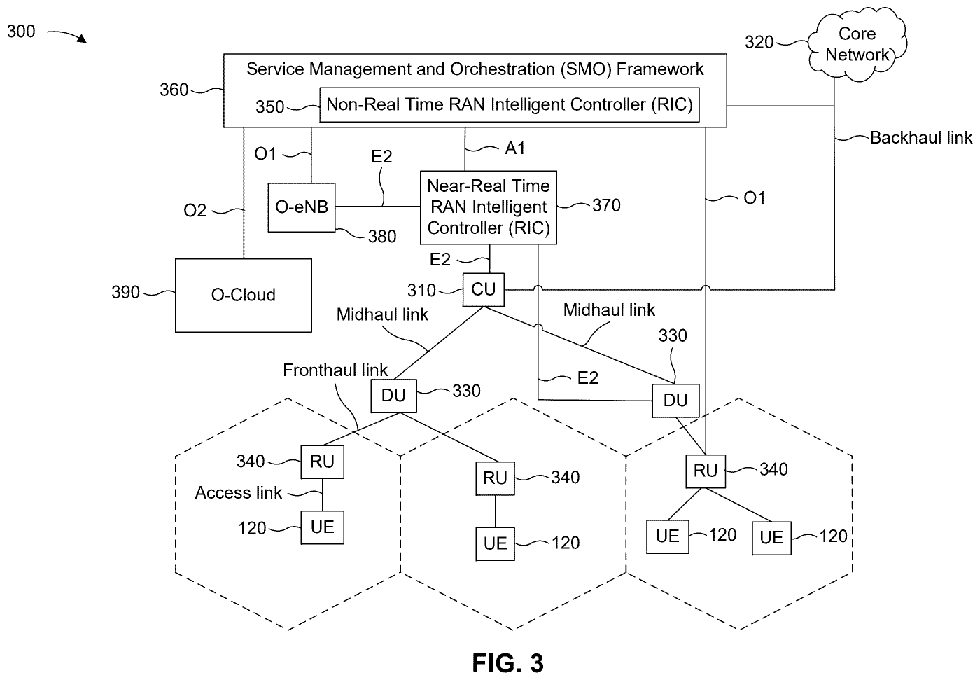

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

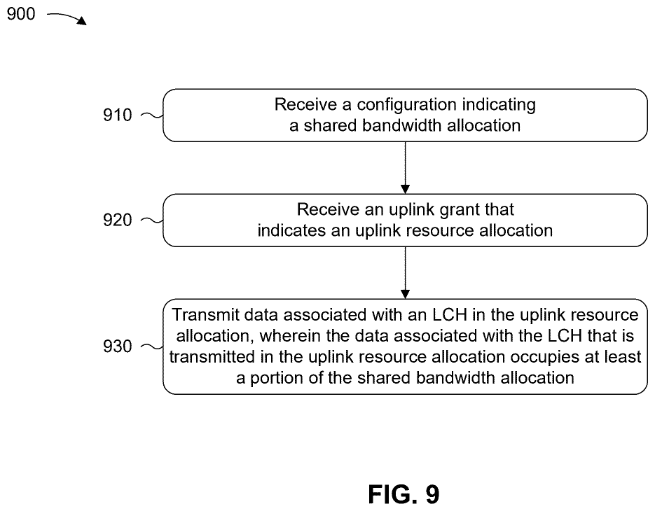

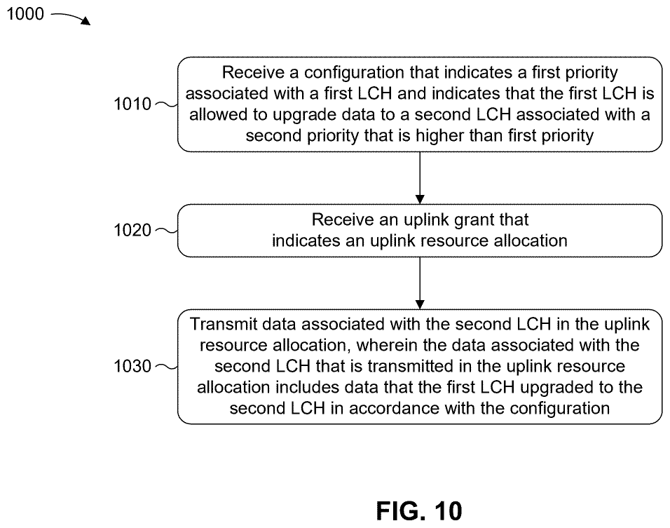

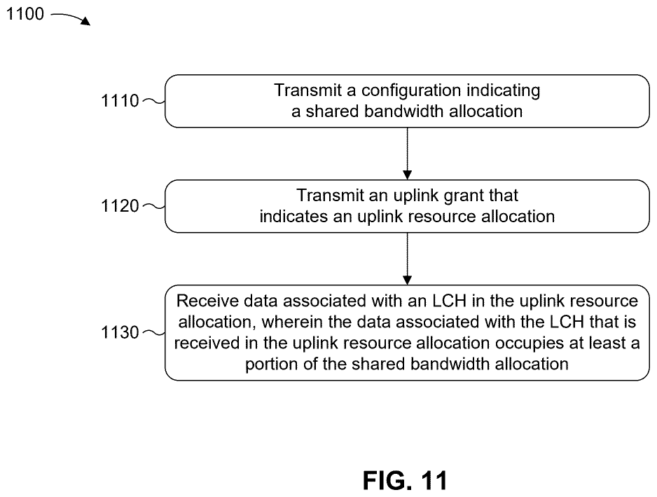

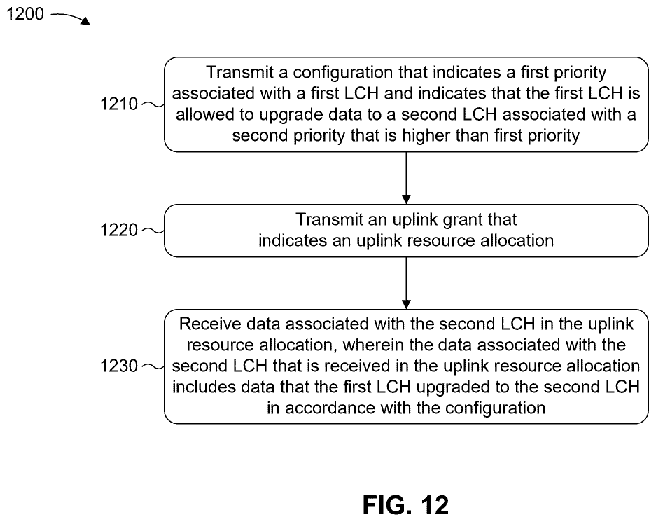

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with dynamic bandwidth allocation and dynamic prioritization for LCHs, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 900 of FIG. 9, process 1000 of FIG. 10, process 1100 of FIG. 11, process 1200 of FIG. 12, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 900 of FIG. 9, process 1000 of FIG. 10, process 1100 of FIG. 11, process 1200 of FIG. 12, or other processes as described herein. In some examples, executing instructions may include running the instructions, converting the instructions, compiling the instructions, and/or interpreting the instructions, among other examples.

As indicated above, FIG. 3 is provided as an example. Other examples may differ from what is described with regard to FIG. 3.

In some aspects, the UE 120 includes means for receiving a configuration indicating a shared bandwidth allocation; means for receiving an uplink grant that indicates an uplink resource allocation; and/or means for transmitting data associated with an LCH in the uplink resource allocation, wherein the data associated with the LCH that is transmitted in the uplink resource allocation occupies at least a portion of the shared bandwidth allocation. Additionally, or alternatively, the UE 120 includes means for receiving a configuration that indicates a first priority associated with a first LCH and indicates that the first LCH is allowed to upgrade data to a second LCH associated with a second priority that is higher than first priority; means for receiving an uplink grant that indicates an uplink resource allocation; and/or means for transmitting data associated with the second LCH in the uplink resource allocation, wherein the data associated with the second LCH that is transmitted in the uplink resource allocation includes data that the first LCH upgraded to the second LCH in accordance with the configuration. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting a configuration indicating a shared bandwidth allocation; means for transmitting an uplink grant that indicates an uplink resource allocation; and/or means for receiving data associated with an LCH in the uplink resource allocation, wherein the data associated with the LCH that is received in the uplink resource allocation occupies at least a portion of the shared bandwidth allocation. Additionally, or alternatively, the network node 110 includes means for transmitting a configuration that indicates a first priority associated with a first LCH and indicates that the first LCH is allowed to upgrade data to a second LCH associated with a second priority that is higher than first priority; means for transmitting an uplink grant that indicates an uplink resource allocation; and/or means for receiving data associated with the second LCH in the uplink resource allocation, wherein the data associated with the second LCH that is received in the uplink resource allocation includes data that the first LCH upgraded to the second LCH in accordance with the configuration. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

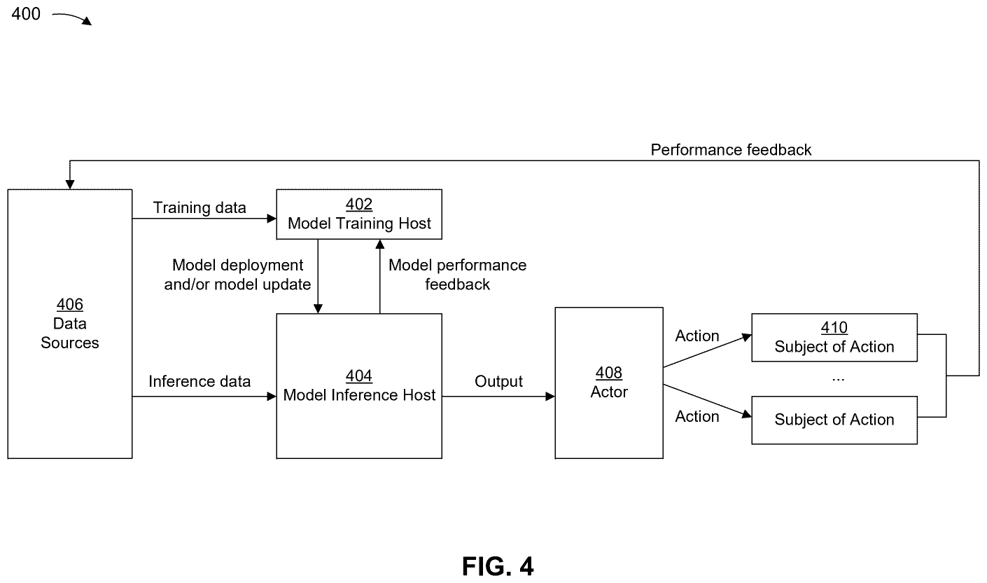

FIG. 4 is a diagram illustrating an example architecture 400 of a functional framework for RAN intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (e.g., the AI functionality and/or the input/output of the component for AI enabled optimization) have been utilized or studied to identify the benefits of AI enabled RAN through possible use cases (e.g., beam management, energy saving, load balancing, mobility management, and/or coverage optimization, among other examples). Furthermore, in some aspects, AI/ML techniques may be used to optimize LCH prioritization techniques in a RAN, such as enabling a network node to configure and/or adapt parameters that enable dynamic bandwidth allocation and/or dynamic prioritization among LCHs, and/or enabling a UE to dynamically distribute a shared bandwidth allocation and/or dynamically upgrade data to an LCH with a higher priority, among other examples. In one example, as shown by the architecture 400, a functional framework for RAN intelligence may include multiple logical entities, such as a model training host 402, a model inference host 404, data sources 406, and an actor 408.

The model inference host 404 may be configured to run an AI/ML model based on inference data provided by the data sources 406, and the model inference host 404 may produce an output (e.g., a prediction) with the inference data input to the actor 408. The actor 408 may be an element or an entity of a core network or a RAN. For example, the actor 408 may be a UE, a network node, base station (e.g., a gNB), a CU, a DU, and/or an RU, among other examples. In addition, the actor 408 may also depend on the type of tasks performed by the model inference host 404, type of inference data provided to the model inference host 404, and/or type of output produced by the model inference host 404. For example, if the output from the model inference host 404 is associated with position determination, the actor 408 may be a UE, a DU or an RU. In another example, if the output from the model inference host 404 is associated with parameters related to a shared bandwidth allocation and/or dynamic prioritization for uplink LCHs, the actor 408 may be a network node. In another example, if the output from the model inference host 404 is associated with parameters related to distributing a shared bandwidth allocation and/or dynamically upgrading a priority for uplink LCHs, the actor 408 may be a UE. In some examples, the model inference host 404 may be hosted on the actor 408. For example, a UE may be the actor 408 and may host the model inference host 404. In some aspects, a UE (e.g., the actor 408) may be a data source 406. For example, the UE may perform a measurement or obtain information (e.g., an NR measurement or a delay requirement associated with buffered data in an LCH), may input the measurement or information to the AI/ML model at the model inference host 404 (or may provide the measurement or information to the model inference host 404), and may act based on an output of the AI/ML model (e.g., may allocate shared bandwidth to an LCH to ensure that the buffered data in the LCH meets the delay requirement).

After the actor 408 receives an output from the model inference host 404, the actor 408 may determine whether to act based on the output. For example, if the actor 408 is a UE and the output from the model inference host 404 is associated with position information, the actor 408 may determine whether to report the position information, reconfigure a beam, among other examples. In another example, if the actor 408 is a network node and the output from the model inference host 404 is associated with predicted data arrival patterns or cell-wide uplink loading, the actor 408 may determine parameters related to a shared bandwidth allocation and/or dynamic prioritization for uplink LCHs, among other examples, according to the output from the model inference host 404. If the actor 408 determines to act based on the output, in some examples, the actor 408 may indicate the action to at least one subject of action 410.

The data sources 406 may also be configured for collecting data that is used as training data for training an ML model or as inference data for feeding an ML model inference operation. For example, the data sources 406 may collect data from one or more core network and/or RAN entities, which may include the actor 408 or the subject of action 410, and provide the collected data to the model training host 402 for ML model training. In some aspects, the model training host 402 may be co-located with the model inference host 404 and/or the actor 408. For example, the actor 408 or the subject of action 410 may provide performance feedback associated with the beam configuration to the data sources 406, where the performance feedback may be used by the model training host 402 for monitoring or evaluating the ML model performance, such as whether the output (e.g., prediction) provided to the actor 408 is accurate. In some examples, the model training host 402 may monitor or evaluate ML model performance using a training position value, which may be provided by a node (e.g., a UE 120 or a network node 110), as described elsewhere herein. In some examples, if the output provided by the actor 408 is inaccurate (or the accuracy is below an accuracy threshold), then the model training host 402 may determine to modify or retrain the ML model used by the model inference host, such as via an ML model deployment/update.

As indicated above, FIG. 4 is provided as an example. Other examples may differ from what is described with regard to FIG. 4.

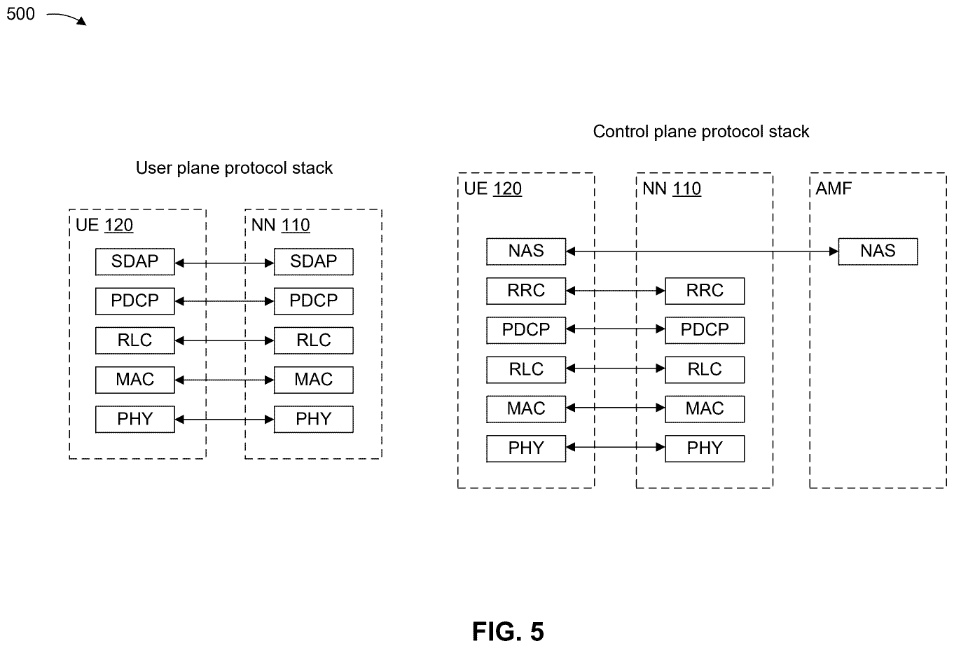

FIG. 5 is a diagram illustrating an example 500 of a user plane protocol stack and a control plane protocol stack for a network node 110 and a core network in communication with a UE 120, in accordance with the present disclosure. In some aspects, the network node 110 may include a plurality of network nodes 110. In some aspects, protocol stack functions of the network node 110 may be distributed across multiple network nodes 110. For example, a first network node 110 may implement a first layer of a protocol stack and a second network node 110 may implement a second layer of the protocol stack. The distribution of the protocol stack across network nodes (in examples where the protocol stack is distributed across network nodes) may be based at least in part on a functional split, as described elsewhere herein. It should be understood that references to “a network node 110” or “the network node 110” can, in some aspects, refer to multiple network nodes.

On the user plane, the UE 120 and the network node 110 may include respective PHY layers, MAC layers, RLC layers, PDCP layers, and SDAP layers. A user plane function (UPF) may handle transport of user data between the UE 120 and the network node 110. On the control plane, the UE 120 and the network node 110 may include respective RRC layers. Furthermore, the UE 120 may include a non-access stratum (NAS) layer in communication with an NAS layer of an AMF. The AMF may be associated with a core network associated with the network node 110, such as a 5G core network (5GC) or a next-generation radio access network (NG-RAN). A control plane function may handle transport of control information between the UE 120 and the core network. Generally, a first layer is referred to as higher than a second layer if the first layer is further from the PHY layer than the second layer. For example, the PHY layer may be referred to as a lowest layer, and the SDAP/PDCP/RLC/MAC layer may be referred to as higher than the PHY layer and lower than the RRC layer. An application (APP) layer, not shown in FIG. 5, may be higher than the SDAP/PDCP/RLC/MAC layer. In some cases, an entity may handle the services and functions of a given layer (e.g., a PDCP entity may handle the services and functions of the PDCP layer), though the description herein refers to the layers themselves as handling the services and functions.

The RRC layer may handle communications related to configuring and operating the UE 120, such as: broadcast of system information related to the access stratum (AS) and the NAS; paging initiated by the 5GC or the NG-RAN; establishment, maintenance, and release of an RRC connection between the UE 120 and the NG-RAN, including addition, modification, and release of carrier aggregation, as well as addition, modification, and release of dual connectivity; security functions including key management; establishment, configuration, maintenance, and release of signaling radio bearers (SRBs) and data radio bearers (DRBs); mobility functions (e.g., handover and context transfer, UE cell selection and reselection and control of cell selection and reselection, inter-RAT mobility); quality of service (QoS) management functions; UE measurement reporting and control of the reporting; detection of and recovery from radio link failure; and NAS message transfer between the NAS layer and the lower layers of the UE 120. The RRC layer is frequently referred to as Layer 3 (L3).

The SDAP layer, PDCP layer, RLC layer, and MAC layer may be collectively referred to as Layer 2 (L2). Thus, in some cases, the SDAP, PDCP, RLC, and MAC layers are referred to as sublayers of Layer 2. On the transmitting side (e.g., if the UE 120 is transmitting an uplink communication or the network node 110 is transmitting a downlink communication), the SDAP layer may receive a data flow in the form of a QoS flow. A QoS flow is associated with a QoS identifier, which identifies a QoS parameter associated with the QoS flow, and a QoS flow identifier (QFI), which identifies the QoS flow. Policy and charging parameters are enforced at the QoS flow granularity. A QoS flow can include one or more service data flows (SDFs), so long as each SDF of a QoS flow is associated with the same policy and charging parameters. In some aspects, the RRC/NAS layer may generate control information to be transmitted and may map the control information to one or more radio bearers for provision to the PDCP layer.

The SDAP layer, or the RRC/NAS layer, may map QoS flows or control information to radio bearers. Thus, the SDAP layer may be said to handle QoS flows on the transmitting side. The SDAP layer may provide the QoS flows to the PDCP layer via the corresponding radio bearers. The PDCP layer may map radio bearers to RLC channels. The PDCP layer may handle various services and functions on the user plane, including sequence numbering, header compression and decompression (if robust header compression is enabled), transfer of user data, reordering and duplicate detection (if in-order delivery to layers above the PDCP layer is required), PDCP protocol data unit (PDU) routing (in case of split bearers), retransmission of PDCP service data units (SDUs), ciphering and deciphering, PDCP SDU discard (e.g., in accordance with a timer, as described elsewhere herein), PDCP re-establishment and data recovery for RLC acknowledged mode (AM), and duplication of PDCP PDUs. The PDCP layer may handle similar services and functions on the control plane, including sequence numbering, ciphering, deciphering, integrity protection, transfer of control plane data, duplicate detection, and duplication of PDCP PDUs.

The PDCP layer may provide data, in the form of PDCP PDUs, to the RLC layer via RLC channels. The RLC layer may handle transfer of upper layer PDUs to the MAC and/or PHY layers, sequence numbering independent of PDCP sequence numbering, error correction via automatic repeat requests (ARQ), segmentation and re-segmentation, reassembly of an SDU, RLC SDU discard, and RLC re-establishment.

The RLC layer may provide data, mapped to logical channels, to the MAC layer. The services and functions of the MAC layer include mapping between logical channels and transport channels (used by the PHY layer as described below), multiplexing/demultiplexing of MAC SDUs belonging to one or different logical channels into/from TBs delivered to/from the PHY layer on transport channels, scheduling information reporting, error correction through hybrid ARQ (HARQ), priority handling between UEs 120 by dynamic scheduling, priority handling between LCHs of one UE 120 by LCH prioritization, and padding.

The MAC layer may package data from LCHs into TBs, and may provide the TBs on one or more transport channels to the PHY layer. The PHY layer may handle various operations relating to transmission of a data signal, as described in more detail in connection with FIG. 2. The PHY layer is frequently referred to as Layer 1 (L1).

On the receiving side (e.g., if the UE 120 is receiving a downlink communication or the network node 110 is receiving an uplink communication), the operations may be similar to those described for the transmitting side, but reversed. For example, the PHY layer may receive TBs and may provide the TBs on one or more transport channels to the MAC layer. The MAC layer may map the transport channels to LCHs and may provide data to the RLC layer via the LCHs. The RLC layer may map the LCHs to RLC channels and may provide data to the PDCP layer via the RLC channels. The PDCP layer may map the RLC channels to radio bearers and may provide data to the SDAP layer or the RRC/NAS layer via the radio bearers.

Data may be passed between the layers in the form of PDUs and SDUs. An SDU is a unit of data that has been passed from a layer or sublayer to a lower layer. For example, the PDCP layer may receive a PDCP SDU. A given layer may then encapsulate the unit of data into a PDU and may pass the PDU to a lower layer. For example, the PDCP layer may encapsulate the PDCP SDU into a PDCP PDU and may pass the PDCP PDU to the RLC layer. The RLC layer may receive the PDCP PDU as an RLC SDU, may encapsulate the RLC SDU into an RLC PDU, and so on. In effect, the PDU carries the SDU as a payload.

As indicated above, FIG. 5 is provided as an example. Other examples may differ from what is described with regard to FIG. 5.

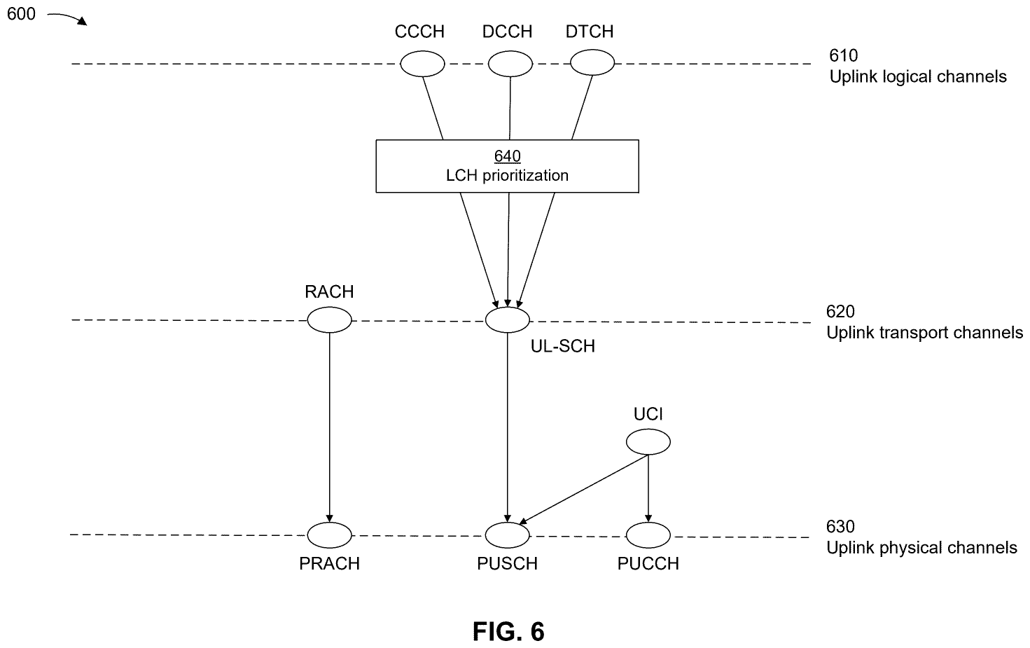

FIG. 6 is a diagram illustrating an example 600 of a mapping among uplink LCHs 610, uplink transport channels 620, and uplink physical channels 630, in accordance with the present disclosure. The uplink LCHs 610, the uplink transport channels 620, and the uplink physical channels 630 are implemented in a UE 120.

For example, as described herein, a UE 120 and a network node 110 may each implement one or more protocol stacks (e.g., a user plane protocol stack and a control plane protocol stack) that include various protocol layers, such as a PHY layer, a MAC layer, and an RLC layer, among other examples. Information flows between different protocol layers, known as channels, are used to segregate and transport different data types across different layers. Accordingly, the channels may provide interfaces between layers within the one or more protocol stacks and enable an orderly and defined data segmentation. For example, LCHs carry user data and signaling messages between the RLC layer and the MAC layer, transport channels carry user data and signaling messages between the MAC layer and the PHY layer, and physical channels carry user data and signaling messages between the UE 120 and the network node 110.

For example, as shown in FIG. 6, uplink LCHs 610 include a CCCH used to carry control information for multiple UEs 120, a dedicated DCCH dedicated to carrying control information for a particular UE 120, and a DTCH dedicated to carrying traffic for a particular UE 120. As further shown in FIG. 6, uplink transport channels 620 include an UL-SCH that is used to carry uplink data and a random access channel (RACH) used for a RACH procedure. As further shown in FIG. 6, the UL-SCH is shared among the CCCH, DCCH, DTCH. Furthermore, as further shown in FIG. 6, uplink physical channels 630 include a PRACH that is mapped to the RACH transport channel and serves as the physical channel through which a UE 120 initiates and/or synchronizes communication with a network node 110, a PUSCH that is mapped to the UL-SCH transport channel and used to carry uplink data from a UE 120 to a network node 110, and a PUCCH used to carry UCI or other control signaling (e.g., acknowledgements or negative acknowledgements for received data, buffer status reports (BSRs), scheduling requests (SRs), and/or CQI information, among other examples) from a UE 120 to a network node 110. In addition, as shown in FIG. 6, the PUSCH may carry UCI in some cases (e.g., UCI may be multiplexed with uplink user data in a PUSCH transmission).

As described herein, the UL-SCH is shared among the CCCH, DCCH, DTCH, whereby a MAC layer may perform an LCH prioritization procedure 640 in the uplink direction to control how UL-SCH resources are shared among different LCHs. For example, when a UE 120 is configured with multiple LCHs 610 that share UL-SCH resources, the MAC layer at the UE 120 may prioritize data from the LCHs 610 according to respective LCH configurations that a network node 110 sends or otherwise provides for the multiple LCHs 610. For example, the LCH configurations may be provided in one or more RRC messages, where the parameters associated with each LCH configuration may include a priority (e.g., an integer from 1 to 16 or another suitable value, where 1 corresponds to a highest priority and 16 corresponds to a lowest priority), a PBR (e.g., a value in kBps), and a BSD (e.g., a value in milliseconds). The PBR and the BSD associated with an LCH 610 may parameterize a leaky bucket regulator associated with the LCH 610, which the MAC layer uses together with the configured priorities to schedule data associated with different LCHs 610 according to a fair priority queuing policy. For example, each LCH 610 is associated with a state variable, Bj, that relates to scheduling eligibility, where the state variable Bj is initialized to zero when an LCH 610 is established. The state variable associated with each LCH 610 is periodically updated (e.g., prior to each execution of the LCH prioritization procedure 640) according to Bj=Bj+PBR×T, where T is a duration or time period since the value of Bj was most recently updated. If Bj has a value that exceeds a bucket size defined as PBR×BSD, the value of Bj is rounded down to the bucket size value.

Accordingly, when an uplink grant is available, the UE 120 initially identifies one or more eligible LCHs 610 (e.g., LCHs 610 that have uplink data and Bj value greater than 0), and starts scheduling data from eligible LCHs 610 according to a descending priority (e.g., from a highest priority to a lowest priority). For example, when scheduling data from an eligible LCH 610, the selected LCH 610 is allocated enough resources to achieve the PBR associated with the LCH 610 (e.g., a transmit buffer associated with the LCH 610 is emptied by at least the value of Bj), and the state variable Bj for the LCH 610 is then updated by subtracting the size of the scheduled data. If the selected LCH 610 has a PBR with an infinite value, the transmit buffer associated with the LCH 610 is emptied completely before serving any other LCH 610. In cases where the uplink grant has spare radio resources remaining after all eligible LCHs 610 have been scheduled, the UE 120 then schedules data from all LCHs 610 according to a strict priority without regard to the Bj value (e.g., not limited to eligible LCHs 610). In this way, the LCH prioritization procedure 640 may maximize throughput and provide relative delay performance across various LCHs 610.

As indicated above, FIG. 6 is provided as an example. Other examples may differ from what is described with regard to FIG. 6.

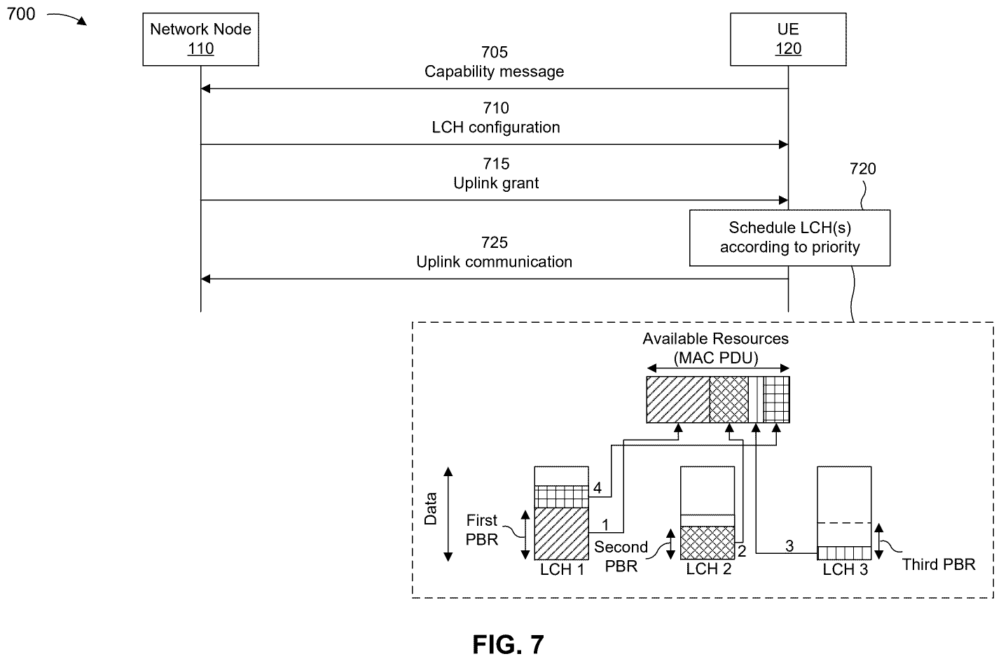

FIG. 7 is a diagram illustrating an example 700 associated with LCH prioritization, in accordance with the present disclosure. As shown in FIG. 7, a network node 110 and a UE 120 may communicate with one another (for example, via a wireless network, such as wireless network 100 of FIG. 1). The network node 110 may include an RU and/or a device controlling the RU, such as a DU and/or a CU. The network node 110 may be associated with at least one TRP (for example, within a cell).

In a first operation 705, the UE 120 may transmit, and the network node 110 may receive, a capability message indicating that the UE 120 is configured for or otherwise supports LCH restrictions. For example, the capability message may include a UECapabilityInformation message, as defined in 3GPP specifications. Accordingly, the UE 120 may indicate that the UE 120 is configured for LCH restrictions using an lcp-Restriction information element (IE), as defined, or otherwise fixed, by a wireless communication standard, such as the 3GPP. In some examples, the network node 110 may transmit, and the UE 120 may receive, a request for the capability message (for example, a UECapabilityEnquiry message, as defined, or otherwise fixed, by a wireless communication standard, such as the 3GPP). The UE 120 may transmit, and the network node 110 may receive, the capability message based on, in response to, or otherwise in association with the request.

In a second operation 710, the network node 110 may transmit, and the UE 120 may receive, a configuration that indicates at least one LCH restriction (e.g., for one or more LCHs in one or more sets or groups of LCHs). For example, in some aspects, the network node 110 may determine an LCH prioritization (LCP) for the UE 120. The network node 110 may determine priorities for respective LCHs. For example, each LCH may be associated with a priority. In some examples, the priority may be an integer value (for example, from 1 to 16, where 1 is a highest priority and 16 is a lowest priority). In some examples, the network node 110 may determine at least one restriction (for example, an LCP restriction) according to a QoS requirement associated with an LCH for the UE 120. As described herein, an LCH may generally reside between an RLC layer and a MAC layer and may facilitate downlink communications from the network node 110 to the UE 120 and/or may facilitate uplink communications from the UE 120 to the network node 110. An LCH may reside in the control plane and carry control information or may reside in the user plane and carry user data.

In one example, the network node 110 may identify delay-sensitive traffic (for example, traffic for an XR application). Accordingly, the network node 110 may determine a restriction for an LCH, to which the delay-sensitive traffic is assigned, that will route the delay-sensitive traffic to a physical channel (for example, to a TRP of the network node 110) with a higher data rate (for example, a lower data load). In another example, the network node 110 may identify error-sensitive traffic (for example, pose updates for an XR application). Accordingly, the network node 110 may determine a restriction for an LCH, to which the error-sensitive traffic is assigned, that will route the error-sensitive traffic to a TRP of the network node 110 with greater robustness (for example, higher quality and/or reliability). In another example, the network node 110 may identify an LCH associated with control information for the UE 120. Accordingly, the network node 110 may determine a restriction for the LCH, to which the control information is assigned, that will route the control information to a TRP of the network node 110 with greater robustness (for example, higher quality and/or reliability).

In some examples, an application service may be a multi-modal service. The multi-modal service may be associated with multi-modal traffic. As used herein, “multi-modal traffic” may refer to traffic that is associated with multiple modes of an application. For example, some applications may generate multiple types of uplink flows of data (for example, multiple modes). For example, an application (for example, an XR application or a virtual reality (VR) application) may generate audio data, video data, positioning data, haptic data, and/or other types of data that are each associated with the application. The different types of uplink flows may be associated with different QoS requirements. For example, video data may be associated with a high data rate, an average reliability requirement (e.g., 99%), and/or an average latency requirement (e.g., 50 milliseconds for uplink). Haptic data or control data may be associated with a low data rate, a high reliability requirement (e.g., 99.99%), and/or a stringent latency requirement (e.g., 20 milliseconds for uplink). The different types of uplink flows may be better served using different radio resources of a wireless network (for example, different TRPs, different RUs, or different network nodes 110). For example, a TRP or an RU deployed at or near a cell edge may enable improved coverage and throughput for UEs located at or near the cell edge. However, traffic routed through the TRP or RU at or near the cell edge may experience additional delays or latency (e.g., compared to traffic transmitted directly to a network node 110 or directly to a base station or DU, such as to a TRP or RU that is co-located with the base station or the DU). Therefore, traffic that has higher data rates and/or less latency sensitivity (e.g., video traffic) may be routed through the TRP or RU deployed at or near the cell edge (e.g., to achieve a higher throughput for the traffic). For other types of traffic that are less delay-sensitive, such as haptic data, control data, or other types of data, the traffic may be routed directly to a network node 110 (e.g., a base station or DU) to reduce the delay or latency.

As another example, TRPs or RUs serving respective carriers on different bands (such as in an inter-band carrier aggregation scenario) may not be co-located. For example, traffic for a given carrier may be routed to a network node (e.g., to a base station or a DU) via one or more midhaul links or one or more backhaul links. In such examples, different types of traffic may be routed to different carriers based on, or otherwise in accordance with, the QoS requirements of the different types of traffic.

In some examples, the network node 110 may determine a PBR for each LCH. The PBR may be a data rate provided to one LCH before allocating any resources to a lower priority LCH. For example, to avoid starvation of some LCHs (for example, to avoid scenarios in which a traffic for a given LCH is unable to be transmitted because higher priority LCHs have traffic that is filling the available resources), the PBR may set a limit for each LCH (e.g., each eligible LCH with a Bj parameter having a value greater than zero). For example, when filling the available resources, the PBR may indicate an amount of data that is to be added from each eligible LCH. If there are any remaining resources, then the available resources may be filled according to the priority of the LCHs (e.g., without limitation to LCHs with a Bj parameter having a value greater than zero).

In the second operation 710, the network node 110 may transmit the configuration information that indicates an LCH configuration for one or more LCHs. An LCH configuration may include a LogicalChannelConfig RRC parameter (for example, as defined, or otherwise fixed, by the 3GPP). The LCH configuration may indicate a priority (for example, an LCH priority), a PBR (for example, via a prioritisedBitRate IE), a BSD (for example, via a bucketSizeDuration IE), and/or other suitable parameters for the LCH associated with the LCH configuration. As described herein, the PBR and the BSD may define a “leaky-bucket regulator” for an LCH (e.g., where PBR×BSD defines a maximum bucket size that sets a maximum value for the Bj state variable used to determine eligible LCHs that have scheduling priority).

In a third operation 715, the network node 110 may transmit, and the UE 120, may receive, an uplink grant that indicates an uplink resource allocation for an uplink transmission by the UE 120. For example, in some aspects, the uplink resource allocation may indicate a TB size or other suitable parameters that define available radio resources for the uplink transmission (e.g., for a MAC PDU to carry data associated with one or more LCHs).

In a fourth operation 720, the UE 120 may select one or more LCHs for traffic to transmit to the network node 110. For example, different LCHs may be associated with different QoS requirements, as described above. In some examples, the UE 120 may select traffic associated with the one or more LCHs to fill available resources for an uplink transmission (for example, to fill a MAC PDU). The UE 120 may select the one or more LCHs based on, responsive to, or otherwise associated with priorities of respective LCHs that are associated with available uplink traffic to be transmitted.

For example, as shown in FIG. 7, an uplink buffer of the UE 120 may indicate that an LCH 1, an LCH 2, and an LCH 3 are associated with uplink traffic that is available to be transmitted. The LCH 1 may be associated with a priority 1 and a first PBR. The LCH 2 may be associated with a priority 2 (for example, indicating a lower priority than the priority 1) and a second PBR. The LCH 3 may be associated with a priority 3 (for example, indicating a lower priority than the priority 1 and the priority 2) and a third PBR.

In the fourth operation 720, the UE 120 may first select traffic from the LCH 1 to be included in the MAC PDU up to an amount of traffic indicated by the first PBR. The UE 120 may second select traffic from the LCH 2 to be included in the MAC PDU up to an amount of traffic indicated by the second PBR. The UE 120 may third select traffic from the LCH 3 to be included in the MAC PDU up to an amount of traffic indicated by the third PBR. As shown in FIG. 7, the LCH 3 may be associated with less traffic than the amount of traffic indicated by the third PBR, enabling the UE 120 to select all the traffic associated with the LCH 3. The UE 120 may fill any remaining space in the available resources (for example, in the MAC PDU) in accordance with the priorities of the LCHs. For example, the UE 120 may fourth fill the remaining space in the available resources (for example, in the MAC PDU) with traffic associated with the LCH 1 (for example, because the LCH 1 has the highest priority). If there are any remaining resources after adding the traffic associated with the LCH 1 to the MAC PDU, then the UE 120 may fill the remaining space in the available resources (for example, in the MAC PDU) with traffic associated with the LCH 2.

In a fifth operation 725, the UE 120 may transmit an uplink communication using the LCH(s). For example, the UE 120 may transmit the uplink communication via the available resources (for example, via the MAC PDU). The traffic (for example, data or control information) included in the uplink communication may be based on, responsive to, or otherwise associated with selection of the traffic in accordance with the LCH priorities (for example, as performed in the fourth operation 720).

As indicated above, FIG. 7 is provided as an example. Other examples may differ from what is described with regard to FIG. 7.

As described herein, when a UE 120 is configured with multiple LCHs that share UL-SCH resources, a MAC layer at the UE 120 may prioritize data from the LCHs according to respective LCH configurations that a network node 110 sends or otherwise provides for the multiple LCHs. For example, the LCH configurations may be provided in one or more RRC messages, where the parameters associated with each LCH configuration may include a PBR (e.g., a value in kBps) and a BSD (e.g., a value in milliseconds) that parameterize a leaky bucket regulator associated with the LCH. The MAC layer may use the leaky bucket regular together with the priorities configured for the LCHs to schedule data associated with the LCHs according to a fair priority queuing policy. For example, each LCH is associated with a scheduling eligibility state variable, Bj, which is initialized to zero when the LCH is established. The state variable associated with each LCH is periodically updated (e.g., prior to each LCH prioritization) according to Bj=Bj+PBR×T, where T is a duration or time period since the value of Bj was most recently updated. If Bj has a value that exceeds a bucket size defined as PBR×BSD, the value of Bj is rounded down to the bucket size value.

Accordingly, when an uplink grant is available, the UE 120 initially identifies one or more eligible LCHs (e.g., LCHs that have uplink data and Bj value greater than 0), and starts scheduling data from eligible LCHs according to a descending priority (e.g., from a highest priority to a lowest priority). For example, when scheduling data from an eligible LCH, the selected LCH is allocated enough resources to achieve the PBR associated with the LCH (e.g., a transmit buffer associated with the LCH is emptied by at least the value of Bj), and the state variable Bj for the LCH is then updated by subtracting the size of the scheduled data. If the selected LCH has a PBR with an infinite value, the transmit buffer associated with the LCH is emptied completely before serving any other LCH. In cases where the uplink grant has spare radio resources remaining after all eligible LCHs with a Bj value greater than 0 have been scheduled, the UE 120 then schedules data from all LCHs according to a strict priority without regard to the Bj value (e.g., not limited to eligible LCHs only). In this way, the LCH prioritization may maximize throughput and provide relative delay performance across various LCHs that share UL-SCH resources.

However, although the LCH prioritization provides acceptable performance for elastic traffic that does not have hard delay requirements, the LCH prioritization procedure poses challenges for delay-sensitive traffic that tends to arrive in bursts, such as XR traffic. For example, when data associated with an LCH is scheduled using an LCH prioritization procedure based on a leaky bucket regulator, there is a tradeoff between latency and uplink capacity. For example, when an uplink traffic burst arrives in a buffer associated with an LCH that has a tight or strict latency requirement, the UE 120 needs to have enough bandwidth to finish sending the entire uplink traffic burst within the required delay budget (e.g., where the burst size divided by the delay requirement is the required bandwidth to meet the delay budget). In other words, a network node may need to allocate the LCH extra bandwidth (e.g., using a high PBR value associated with a maximum uplink data burst size) in order to meet the delay requirement associated with the LCH. Accordingly, in cases where the network node 110 allocates bandwidth according to a maximum burst size, the allocated bandwidth may exceed an average data rate, which may result in the allocated bandwidth not being fully utilized because different uplink traffic bursts may have different sizes (e.g., for any uplink traffic bursts that are less than the maximum burst size). As a result, when extra bandwidth is allocated to an LCH to meet a latency requirement, uplink capacity may be utilized less efficiently because unused bandwidth allocated to an LCH cannot be used by other LCHs due to a hard partition among LCHs. Accordingly, some aspects described herein generally relate to dynamic bandwidth allocation and/or dynamic prioritization for LCHs, to better balance tradeoffs between latency and uplink capacity.

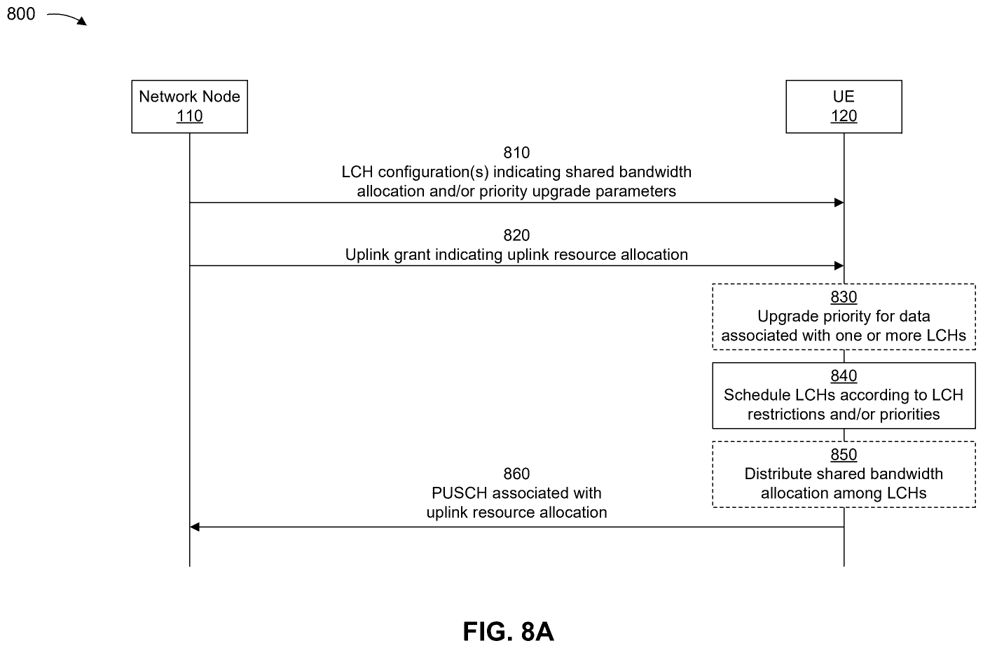

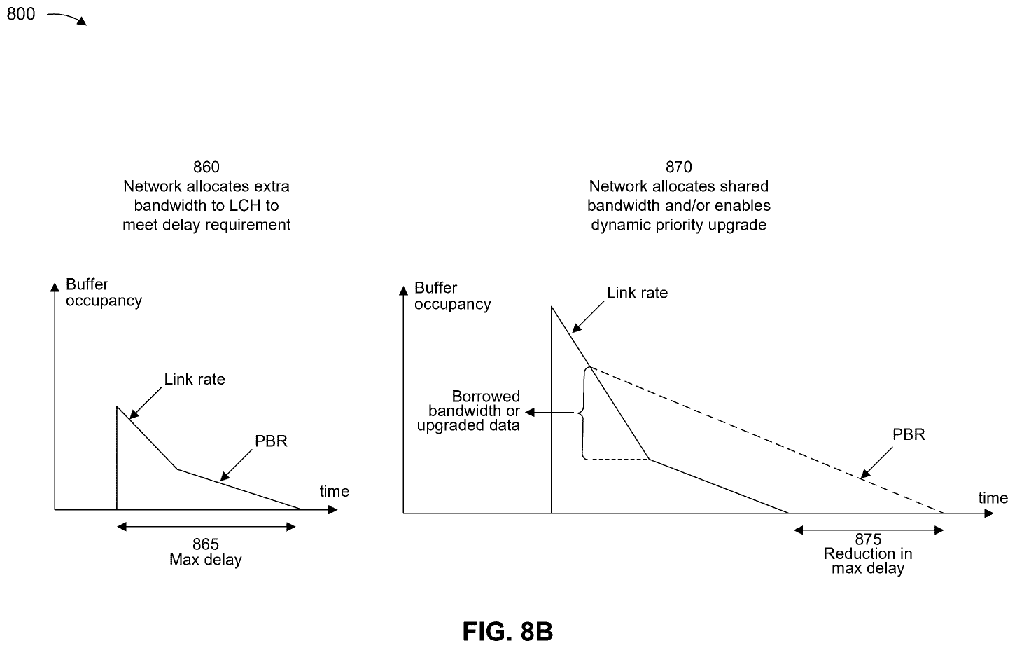

FIGS. 8A-8B are diagrams illustrating an example 800 associated with dynamic bandwidth allocation and dynamic prioritization for LCHs. As shown in FIG. 8A, example 800 includes a network node 110 and a UE 120 that may communicate in a wireless network, such as wireless network 100. The network node 110 and the UE 120 may communicate via a wireless access link, which includes an uplink and a downlink.

As shown in FIG. 8A, and by reference number 810, the network node 110 may transmit, and the UE 120 may receive, one or more LCH configurations. For example, in some aspects, the network node 110 may provide a respective LCH configuration associated with each LCH that the network node 110 configures for the UE 120. For example, as described herein, an LCH configuration may be provided in RRC signaling (e.g., in a LogicalChannelConfig information element), and may indicate various parameters such as a priority (e.g., a value from 1 to 16, where 1 is a highest priority and 16 is a lowest priority), a PBR (e.g., 0, 8, 16, 32, . . . , 32768, or 65536 kBps, or infinity), and a BSD (e.g., 5, 10, 20, 50, 100, 150, 300, 500, or 1000 milliseconds), where the PBR and the BSD parameterize a leaky bucket regulator for the LCH. For example, the UE 120 may maintain a state variable, Bj, for each LCH, which may be initialized to 0 when the LCH is established and incremented at a rate associated with the PBR, according to Bj=Bj+PBR×T, where T is a duration or time period since the value of Bj was most recently updated and PBR×BSD is a maximum value for Bj.

In some aspects, the LCH configuration may indicate one or more parameters that relate to scheduling restrictions for each LCH, such as subcarrier spacings allowed for uplink transmission, a maximum PUSCH duration allowed for uplink transmission, whether a configured grant (CG) can be used for uplink transmission, and/or serving cells allowed for uplink transmission, among other examples. In some aspects, the LCH configuration may indicate other suitable parameters, such as an identifier associated with an LCH group that includes the LCH and/or an identifier associated with an SR configuration applicable to the LCH, among other examples.

Furthermore, in addition to the various parameters described above, which may be used in an LCH prioritization procedure to determine whether an LCH is eligible to receive prioritized scheduling when an uplink grant is available, the LCH configuration may configure a shared bandwidth allocation that can be shared among multiple LCHs. For example, in some aspects, the shared bandwidth allocation may be configured at a top-level (e.g., associated with a MAC entity of the UE 120), such that the shared bandwidth allocation is available to all LCHs associated with the UE 120. Additionally, or alternatively, the shared bandwidth allocation can be configured at a scheduling group level, where an LCH scheduling group may generally include a set of LCHs that are scheduled using the same scheduling policy (e.g., a first come first serve (FCFS) policy, a fair priority queueing (FPQ) policy, an earliest deadline first (EDF) policy, and/or another suitable scheduling policy). In some aspects, when the shared bandwidth allocation is configured at a scheduling group level, the shared bandwidth allocation may be available only to LCHs in a particular scheduling group rather than all LCHs configured for the UE 120 (e.g., a scheduling group that includes LCHs associated with QoS requirements, latency requirements, data rates, maximum data burst sizes, and/or other suitable attributes that may warrant allocating additional instantaneous bandwidth to the LCHs in the scheduling group). Additionally, or alternatively, shared bandwidth allocations may be separately configured for different LCH scheduling groups (e.g., a first shared bandwidth allocation may be configured for a first LCH scheduling group, a second shared bandwidth allocation may be configured for a second LCH scheduling group, and so on).

In some aspects, as described herein, the network node 110 may configure a top-level shared bandwidth allocation and/or an LCH group-specific shared bandwidth allocation as a leaky bucket regulator associated with a PBR value and BSD value that controls a size of the shared bandwidth allocation. For example, in some aspects, the shared bandwidth allocation may generally include T bandwidth tokens at any particular time, where each bandwidth token corresponds to a unit of bandwidth (e.g., a number of bytes) and the bandwidth tokens are generated at a rate associated with the configured PBR value (e.g., N bandwidth tokens are generated per second, where N has a value that depends on the PBR value). Furthermore, the number of bandwidth tokens in the shared bandwidth allocation, T, may be limited to a maximum number such that a size of the shared bandwidth allocation is capped at PBR×BSD. Accordingly, in any scheduling interval, an LCH that has access to a shared bandwidth allocation can obtain up to T bandwidth tokens to obtain additional instantaneous bandwidth (e.g., in addition to any bandwidth associated with a leaky bucket regular parameterized according to the PBR value and the BSD value that are configured for the LCH), where Tis then decremented according to the number of bandwidth tokens obtained by the LCH. Additionally, or alternatively, the network node 110 may configure the shared bandwidth allocation according to a sliding window of bandwidth tokens. For example, when the shared bandwidth allocation is configured according to a sliding window of bandwidth tokens, an LCH that has access to a shared bandwidth allocation can obtain up to N bandwidth tokens in the last T time slots, transmission time intervals (TTIs), seconds, or other suitable duration or time period, where N and T are parameters having values configured by the network node 110. Furthermore, in some aspects, each bandwidth token may have a size configured by the network node 110, or a fixed size (e.g., defined in a wireless communication standard).

In some aspects, the network node 110 may update the configuration associated with the shared bandwidth allocation. For example, in some aspects, the network node 110 may update the configuration associated with the shared bandwidth allocation to change the PBR value and/or BSD value for a shared leaky bucket regulator, or to change the N value and/or the T value for a sliding window of shared bandwidth tokens. In some aspects, the network node 110 may update the configuration associated with the shared bandwidth allocation at periodic intervals, in response to a triggering event, or in association with other suitable criteria. In some aspects, the network node 110 may update the configuration for a shared leaky bucket regulator or a sliding window of shared bandwidth tokens according to one or more parameters or measurements that relate to network conditions (e.g., cell-wide uplink loading), a state associated with the UE 120 (e.g., a change in a maximum burst size or latency requirement), and/or one or more predictions (e.g., predicted data arrival patterns or predicted changes in network conditions, among other examples) that may be obtained using an AI/ML model, statistical analysis, and/or other suitable predictive techniques.

Additionally, or alternatively, in some aspects, the LCH configuration(s) provided by the network node 110 may indicate that one or more LCHs are permitted or otherwise allowed to upgrade data associated with the LCH to another LCH associated with a higher priority. As described herein, upgrading data to a different LCH may be equivalent to upgrading the data to a different (e.g., higher) priority, because an LCH and a priority generally have a one-to-one mapping (e.g., indicated in the LCH configuration associated with the LCH). In some aspects, when an LCH configuration allows an LCH to upgrade data to a different LCH with a higher priority, the amount of data that can be upgraded to the higher priority may be controlled according to a leaky bucket regulator that may be configured in a similar manner as a shared bandwidth allocation. For example, in addition to the PBR and BSD that parameterizes the leaky bucket regulator for an LCH, a separate PBR and BSD parameter paid may be configured to parameterize the leaky bucket regulator that defines the amount of data that the LCH can upgrade to a different LCH having a higher priority. Additionally, or alternatively, the network node 110 may configure the amount of data that can be upgraded according to a sliding time window. For example, an LCH configuration may indicate that an LCH is allowed to upgrade up to N bytes in a sliding time period, which correspond to the last T time slots or other TTIs, the last T seconds, or another suitable duration or time period, where N and T may be configured by the network node 110.

In some aspects, the network node 110 may update the configuration associated with the amount of data that an LCH can upgrade to another LCH with a higher priority. For example, in some aspects, the network node 110 may update the configuration associated with the amount of data that can be upgraded by changing the PBR value and/or BSD value for the associated leaky bucket regulator, or by changing the N value (e.g., the maximum amount of bytes that can be upgraded in the sliding time window) and/or the T value (e.g., the length of the sliding time window). In some aspects, the network node 110 may update the configuration associated with the amount of data that can be upgraded to a higher priority at periodic intervals, in response to a triggering event, or in association with other suitable criteria. In some aspects, the network node 110 may update the configuration for a leaky bucket regulator or a sliding time window defining the amount of data that can be upgraded according to one or more parameters or measurements that relate to network conditions (e.g., cell-wide uplink loading), a state associated with the UE 120 (e.g., a change in a maximum burst size or latency requirement), and/or one or more predictions (e.g., predicted data arrival patterns or predicted changes in network conditions, among other examples) obtained using an AI/ML model, statistical analysis, and/or other suitable predictive techniques.

As shown by reference number 820, the network node 110 may transmit, and the UE 120 may receive, an uplink grant that indicates an uplink resource allocation. For example, in some aspects, the uplink resource allocation may indicate an amount of UL-SCH resources, a size for a MAC PDU, an amount of radio resources, and/or other suitable information that defines an allocated size for an uplink transmission.

As shown by reference number 830, the UE 120 may dynamically upgrade a priority for data associated with one or more LCHs to other LCHs that have a higher priority. For example, in some aspects, the UE 120 may identify one or more LCHs that are associated with a configuration that allows data associated with the respective LCHs to be upgraded to a different LCH with a higher priority. In some aspects, for any LCH associated with a configuration that allows data associated with the LCH to be upgraded to a different LCH with a higher priority, the UE 120 may determine a maximum amount of data that can be upgraded to the LCH with the higher priority. For example, as described herein, the amount of data that the LCH can upgrade to an LCH with a higher priority may be controlled according to a leaky bucket regulator that holds T bandwidth tokens (where T is limited to a maximum value according to PBR×BSD and a size of each bandwidth token), or according to a sliding time window that allows up to N bytes to upgraded over a duration having a length T. Accordingly, in cases where the UE 120 upgrades data associated with an LCH to another LCH with a higher priority using a leaky bucket regulator, the UE 120 may upgrade up to T bandwidth tokens from the leaky bucket regulator, and a value of T may then be decremented by the number of bandwidth tokens that were borrowed or otherwise obtained from the leaky bucket regulator. Similarly, in cases where the UE 120 upgrades data associated with an LCH to another LCH with a higher priority within a sliding time window-based regulator, the UE 120 may upgrade up to N-M bytes to a higher priority, where M is the number of bytes that have been upgraded in the last T slots, the last T seconds, or other duration. In some aspects, the UE 120 may determine whether to upgrade data to an LCH with a higher priority and/or how much data to upgrade to the LCH with the higher priority according to one or more parameters or measurements that relate to a scheduling state associated with the UE 120 (e.g., a change in a maximum burst size or latency requirement) and/or one or more predictions (e.g., predicted data arrival patterns) that may be obtained using an AI/ML model, statistical analysis, and/or other techniques.

As shown by reference number 840, the UE 120 may schedule one or more LCHs within the uplink resource allocation in accordance with one or more LCH restrictions and/or priorities. For example, as described herein, the UE 120 may initially identify one or more eligible LCHs (e.g., LCHs that have buffered uplink data and a Bj state variable with a value greater than 0), and may start scheduling data from eligible LCHs according to a descending priority (e.g., from a highest priority to a lowest priority). Furthermore, in some aspects, the eligible LCHs may satisfy any other applicable scheduling restrictions (e.g., if the uplink grant indicates a subcarrier spacing and a serving cell for the uplink transmission, the eligible LCHs may be limited to LCHs for which the indicated subcarrier spacing and serving cell are in a set of allowed subcarrier spacings and a set of allowed serving cells). In some aspects, when scheduling data from an eligible LCH, the selected LCH is allocated enough resources to achieve the PBR associated with the LCH (e.g., a transmit buffer associated with the LCH is emptied by at least the value of Bj), and the state variable Bj for the LCH is then updated by subtracting the size of the scheduled data. If the selected LCH has a PBR with an infinite value, the transmit buffer associated with the LCH is emptied before serving any other LCH. In cases where the uplink grant has spare radio resources remaining after scheduling all eligible LCHs with a Bj value greater than 0, the UE 120 then schedules data from all LCHs according to strict priority without regard to the Bj value (e.g., not limited to eligible LCHs only).

As shown by reference number 850, the UE 120 may distribute any shared bandwidth allocation(s) shared among all LCHs associated with the UE 120 and/or the LCH scheduling group(s) that share the shared bandwidth allocation(s). For example, when scheduling the LCH data as described above, the UE 120 may reserve all or a portion of the shared bandwidth allocation(s) within the uplink resource allocation indicated in the uplink grant. Accordingly, the UE 120 may then distribute the shared bandwidth allocation(s) or the reserved portion(s) of the shared bandwidth allocation(s) among the LCHs that share the applicable shared bandwidth allocation(s). For example, an LCH may borrow or otherwise obtain up to T bandwidth tokens from a leaky bucket regulator that defines the shared bandwidth allocation, and a value of T may then be decremented by the number of bandwidth tokens that were borrowed or otherwise obtained from the leaky bucket regulator. Similarly, in cases where the shared bandwidth allocation is defined according to a sliding time window-based regulator, the UE 120 may distribute up to N-M bandwidth tokens, where M is the number of bandwidth tokens that have been distributed in the last T slots, the last T seconds, or other duration. In some aspects, the UE 120 may determine whether to distribute the shared bandwidth allocation(s) and/or how much of the shared bandwidth allocation(s) to distribute among LCHs according to one or more parameters or measurements that relate to a scheduling state associated with the UE 120 (e.g., a change in a maximum burst size or a latency requirement associated with a traffic burst) and/or one or more predictions (e.g., predicted data arrival patterns) that may be obtained using an AI/ML model, statistical analysis, and/or other techniques. In some aspects, in cases where the UE 120 determines to not distribute the shared bandwidth allocation(s) and/or to distribute only a portion of the shared bandwidth allocation(s) among LCHs, any unused portion of the shared bandwidth allocation(s) may be made available to eligible LCHs and/or added to the spare resources (if any) used to schedule all LCHs.

As shown by reference number 850, the UE 120 may transmit, and the network node 110 may receive, a PUSCH in the uplink resource allocation. For example, in some aspects, at least a portion of the uplink resource allocation may be associated with the shared bandwidth allocation, and occupied by data associated with one or more LCHs that share the shared bandwidth allocation (e.g., to obtain additional instantaneous bandwidth to meet a latency requirement). Additionally, or alternatively, a portion of the uplink resource allocation may be associated with data that was upgraded to an LCH with a higher priority (e.g., to an eligible LCH, or to otherwise increase a probability that the data will be scheduled within an available uplink grant). In this way, some aspects described herein may provide dynamic bandwidth allocation and/or dynamic prioritization for LCHs, to better balance tradeoffs between latency and uplink capacity. For example, referring to FIG. 8B, reference number 860 corresponds to a scenario where the network node 110 allocates extra bandwidth to an LCH (e.g., according to a maximum traffic burst size) for at least a portion of time (e.g., shown by a link rate having a steeper slope than a PBR associated with the LCH) in order to satisfy a maximum delay 865 associated with the uplink traffic. Alternatively, reference number 870 corresponds to a scenario where the network node 110 provides a shared bandwidth allocation and/or allows one or more LCHs to upgrade data to another LCH with a higher priority, according to some aspects described herein. In such cases, as shown, one or more LCHs may borrow or otherwise obtain at least a portion of the shared bandwidth allocation, or upgrade at least some data to another LCH with a higher priority, which reduces the time that extra bandwidth is allocated and/or provides a reduction 875 in the maximum delay associated with the LCH data.

As indicated above, FIGS. 8A-8B are provided as an example. Other examples may differ from what is described with regard to FIGS. 8A-8B.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with dynamic bandwidth allocation for LCHs.

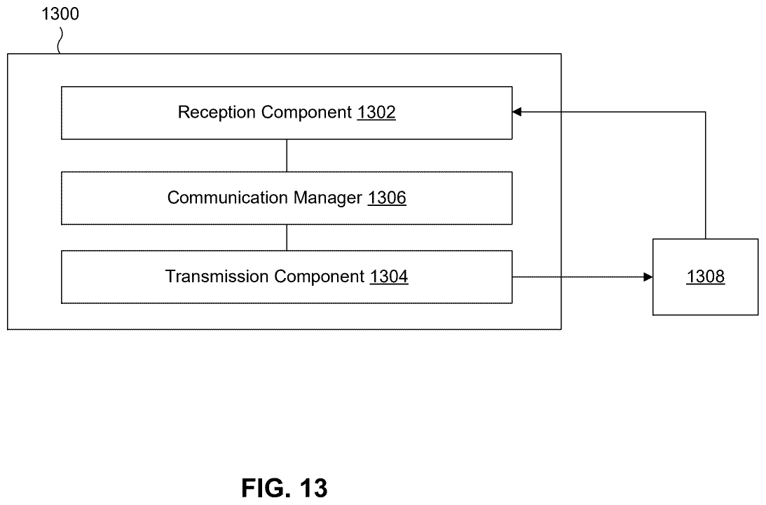

As shown in FIG. 9, in some aspects, process 900 may include receiving a configuration indicating a shared bandwidth allocation (block 910). For example, the UE (e.g., using reception component 1302 and/or communication manager 1306, depicted in FIG. 13) may receive a configuration indicating a shared bandwidth allocation, as described above.

As further shown in FIG. 9, in some aspects, process 900 may include receiving an uplink grant that indicates an uplink resource allocation (block 920). For example, the UE (e.g., using reception component 1302 and/or communication manager 1306, depicted in FIG. 13) may receive an uplink grant that indicates an uplink resource allocation, as described above.

As further shown in FIG. 9, in some aspects, process 900 may include transmitting data associated with an LCH in the uplink resource allocation, wherein the data associated with the LCH that is transmitted in the uplink resource allocation occupies at least a portion of the shared bandwidth allocation (block 930). For example, the UE (e.g., using transmission component 1304 and/or communication manager 1306, depicted in FIG. 13) may transmit data associated with an LCH in the uplink resource allocation, wherein the data associated with the LCH that is transmitted in the uplink resource allocation occupies at least a portion of the shared bandwidth allocation, as described above.

Process 900 may include additional aspects, such as any single aspect or any combination of aspects described below and/or in connection with one or more other processes described elsewhere herein.

In a first aspect, the shared bandwidth allocation includes a first number of shared bandwidth tokens, and wherein the data associated with the LCH that occupies the portion of the shared bandwidth allocation uses a second number of shared bandwidth tokens that does not exceed the first number of shared bandwidth tokens.

In a second aspect, alone or in combination with the first aspect, the shared bandwidth allocation includes a first number of shared bandwidth tokens that is decremented by a second number of shared bandwidth tokens used by the data associated with the LCH that occupies the portion of the shared bandwidth allocation.

In a third aspect, alone or in combination with one or more of the first and second aspects, the configuration indicates the shared bandwidth allocation according to at least a PBR and a BSD.

In a fourth aspect, alone or in combination with one or more of the first through third aspects, the shared bandwidth allocation includes a set of shared bandwidth tokens that are generated at a rate associated with the PBR.

In a fifth aspect, alone or in combination with one or more of the first through fourth aspects, a maximum number of shared bandwidth tokens in the set of shared bandwidth tokens is a product of the PBR and the BSD.

In a sixth aspect, alone or in combination with one or more of the first through fifth aspects, the configuration indicates the shared bandwidth allocation according to a maximum number of bandwidth tokens in a sliding time window.

In a seventh aspect, alone or in combination with one or more of the first through sixth aspects, the data associated with the LCH that is transmitted in the uplink resource allocation occupies the portion of the shared bandwidth allocation in accordance with a delay requirement.

In an eighth aspect, alone or in combination with one or more of the first through seventh aspects, process 900 includes distributing, within the uplink resource allocation, the shared bandwidth allocation among LCHs in an LCH group that includes the LCH.

In a ninth aspect, alone or in combination with one or more of the first through eighth aspects, the shared bandwidth allocation is distributed among the LCHs in the LCH group according to information generated by an AI/ML model.

In a tenth aspect, alone or in combination with one or more of the first through ninth aspects, the LCH group is an LCH scheduling group that includes one or more LCHs associated with a scheduling policy.

In an eleventh aspect, alone or in combination with one or more of the first through tenth aspects, process 900 includes receiving an updated configuration indicating a change to one or more parameters associated with the shared bandwidth allocation.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a UE or an apparatus of a UE, in accordance with the present disclosure. Example process 1000 is an example where the apparatus or the UE (e.g., UE 120) performs operations associated with dynamic bandwidth allocation for LCHs.

As shown in FIG. 10, in some aspects, process 1000 may include receiving a configuration that indicates a first priority associated with a first LCH and indicates that the first LCH is allowed to upgrade data to a second LCH associated with a second priority that is higher than first priority (block 1010). For example, the UE (e.g., using reception component 1302 and/or communication manager 1306, depicted in FIG. 13) may receive a configuration that indicates a first priority associated with a first LCH and indicates that the first LCH is allowed to upgrade data to a second LCH associated with a second priority that is higher than first priority, as described above.

As further shown in FIG. 10, in some aspects, process 1000 may include receiving an uplink grant that indicates an uplink resource allocation (block 1020). For example, the UE (e.g., using reception component 1302 and/or communication manager 1306, depicted in FIG. 13) may receive an uplink grant that indicates an uplink resource allocation, as described above.

As further shown in FIG. 10, in some aspects, process 1000 may include transmitting data associated with the second LCH in the uplink resource allocation, wherein the data associated with the second LCH that is transmitted in the uplink resource allocation includes data that the first LCH upgraded to the second LCH in accordance with the configuration (block 1030). For example, the UE (e.g., using transmission component 1304 and/or communication manager 1306, depicted in FIG. 13) may transmit data associated with the second LCH in the uplink resource allocation, wherein the data associated with the second LCH that is transmitted in the uplink resource allocation includes data that the first LCH upgraded to the second LCH in accordance with the configuration, as described above.

Process 1000 may include additional aspects, such as any single aspect or any combination of aspects described below and/or in connection with one or more other processes described elsewhere herein.

In a first aspect, the configuration indicates a maximum amount of data that the first LCH is allowed to upgrade to the second LCH.

In a second aspect, alone or in combination with the first aspect, the maximum amount of data that the first LCH is allowed to upgrade to the second LCH is indicated according to a PBR and a BSD.

In a third aspect, alone or in combination with one or more of the first and second aspects, the maximum amount of data that the first LCH is allowed to upgrade to the second LCH increases at a rate associated with the PBR.

In a fourth aspect, alone or in combination with one or more of the first through third aspects, the maximum amount of data that the first LCH is allowed to upgrade to the second LCH is a product of the PBR and the BSD.

In a fifth aspect, alone or in combination with one or more of the first through fourth aspects, the configuration indicates a sliding time window associated with the maximum amount of data that the first LCH is allowed to upgrade to the second LCH.

In a sixth aspect, alone or in combination with one or more of the first through fifth aspects, process 1000 includes receiving an updated configuration indicating a change to the maximum amount of data that the first LCH is allowed to upgrade to the second LCH.

In a seventh aspect, alone or in combination with one or more of the first through sixth aspects, the data is upgraded from the first LCH upgraded to the second LCH according to information generated by an AI/ML model.

In an eighth aspect, alone or in combination with one or more of the first through seventh aspects, a size of the data upgraded from the first LCH upgraded to the second LCH is determined according to information generated by an AI/ML model.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network node or an apparatus of a network node, in accordance with the present disclosure. Example process 1100 is an example where the apparatus or the network node (e.g., network node 110) performs operations associated with dynamic prioritization for LCHs.

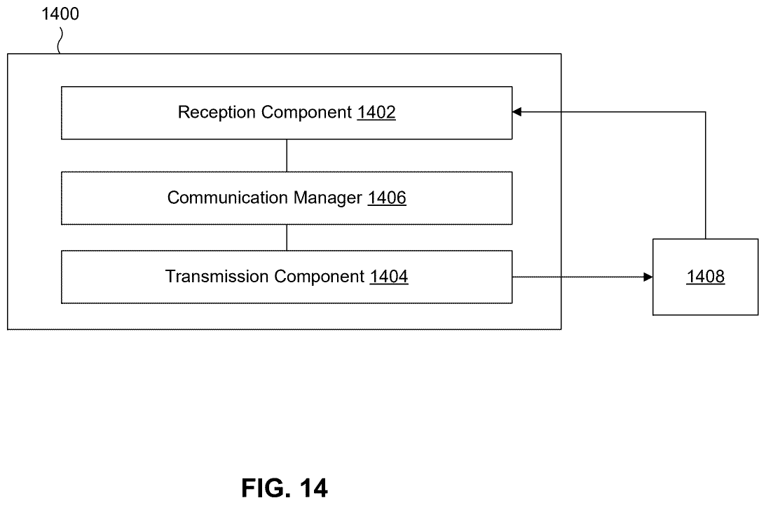

As shown in FIG. 11, in some aspects, process 1100 may include transmitting a configuration indicating a shared bandwidth allocation (block 1110). For example, the network node (e.g., using transmission component 1404 and/or communication manager 1406, depicted in FIG. 14) may transmit a configuration indicating a shared bandwidth allocation, as described above.

As further shown in FIG. 11, in some aspects, process 1100 may include transmitting an uplink grant that indicates an uplink resource allocation (block 1120). For example, the network node (e.g., using transmission component 1404 and/or communication manager 1406, depicted in FIG. 14) may transmit an uplink grant that indicates an uplink resource allocation, as described above.

As further shown in FIG. 11, in some aspects, process 1100 may include receiving data associated with an LCH in the uplink resource allocation, wherein the data associated with the LCH that is received in the uplink resource allocation occupies at least a portion of the shared bandwidth allocation (block 1130). For example, the network node (e.g., using reception component 1402 and/or communication manager 1406, depicted in FIG. 14) may receive data associated with an LCH in the uplink resource allocation, wherein the data associated with the LCH that is received in the uplink resource allocation occupies at least a portion of the shared bandwidth allocation, as described above.

Process 1100 may include additional aspects, such as any single aspect or any combination of aspects described below and/or in connection with one or more other processes described elsewhere herein.

In a first aspect, the configuration indicates the shared bandwidth allocation according to a PBR and a BSD.

In a second aspect, alone or in combination with the first aspect, the configuration indicates the shared bandwidth allocation according to a maximum number of bandwidth tokens in a sliding time window.

In a third aspect, alone or in combination with one or more of the first and second aspects, the data associated with the LCH that is received in the uplink resource allocation occupies the portion of the shared bandwidth allocation in accordance with a delay requirement.

In a fourth aspect, alone or in combination with one or more of the first through third aspects, the shared bandwidth allocation is associated with an LCH scheduling group that includes one or more LCHs associated with a scheduling policy.

In a fifth aspect, alone or in combination with one or more of the first through fourth aspects, process 1100 includes transmitting an updated configuration indicating a change to one or more parameters associated with the shared bandwidth allocation.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network node or an apparatus of a network node, in accordance with the present disclosure. Example process 1200 is an example where the apparatus or the network node (e.g., network node 110) performs operations associated with dynamic prioritization for LCHs.

As shown in FIG. 12, in some aspects, process 1200 may include transmitting a configuration that indicates a first priority associated with a first LCH and indicates that the first LCH is allowed to upgrade data to a second LCH associated with a second priority that is higher than first priority (block 1210). For example, the network node (e.g., using transmission component 1404 and/or communication manager 1406, depicted in FIG. 14) may transmit a configuration that indicates a first priority associated with a first LCH and indicates that the first LCH is allowed to upgrade data to a second LCH associated with a second priority that is higher than first priority, as described above.

As further shown in FIG. 12, in some aspects, process 1200 may include transmitting an uplink grant that indicates an uplink resource allocation (block 1220). For example, the network node (e.g., using transmission component 1404 and/or communication manager 1406, depicted in FIG. 14) may transmit an uplink grant that indicates an uplink resource allocation, as described above.

As further shown in FIG. 12, in some aspects, process 1200 may include receiving data associated with the second LCH in the uplink resource allocation, wherein the data associated with the second LCH that is received in the uplink resource allocation includes data that the first LCH upgraded to the second LCH in accordance with the configuration (block 1230). For example, the network node (e.g., using reception component 1402 and/or communication manager 1406, depicted in FIG. 14) may receive data associated with the second LCH in the uplink resource allocation, wherein the data associated with the second LCH that is received in the uplink resource allocation includes data that the first LCH upgraded to the second LCH in accordance with the configuration, as described above.

Process 1200 may include additional aspects, such as any single aspect or any combination of aspects described below and/or in connection with one or more other processes described elsewhere herein.

In a first aspect, the configuration indicates a maximum amount of data that the first LCH is allowed to upgrade to the second LCH.

In a second aspect, alone or in combination with the first aspect, the maximum amount of data that the first LCH is allowed to upgrade to the second LCH is indicated according to a PBR and a BSD.

In a third aspect, alone or in combination with one or more of the first and second aspects, the configuration indicates a sliding time window associated with the maximum amount of data that the first LCH is allowed to upgrade to the second LCH.

In a fourth aspect, alone or in combination with one or more of the first through third aspects, process 1200 includes transmitting an updated configuration indicating a change to the maximum amount of data that the first LCH is allowed to upgrade to the second LCH.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 140 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 8A-8B. Additionally, or alternatively, the apparatus 1300 may be configured to perform one or more processes described herein, such as process 900 of FIG. 9, process 1000 of FIG. 10, or a combination thereof. In some aspects, the apparatus 1300 and/or one or more components shown in FIG. 13 may include one or more components of the UE described in connection with FIG. 1 and FIG. 2. Additionally, or alternatively, one or more components shown in FIG. 13 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive a configuration indicating a shared bandwidth allocation. The reception component 1302 may receive an uplink grant that indicates an uplink resource allocation. The transmission component 1304 may transmit data associated with an LCH in the uplink resource allocation, wherein the data associated with the LCH that is transmitted in the uplink resource allocation occupies at least a portion of the shared bandwidth allocation.

The reception component 1302 may receive a configuration that indicates a first priority associated with a first LCH and indicates that the first LCH is allowed to upgrade data to a second LCH associated with a second priority that is higher than first priority. The reception component 1302 may receive an uplink grant that indicates an uplink resource allocation. The transmission component 1304 may transmit data associated with the second LCH in the uplink resource allocation, wherein the data associated with the second LCH that is transmitted in the uplink resource allocation includes data that the first LCH upgraded to the second LCH in accordance with the configuration.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 8A-8B. Additionally, or alternatively, the apparatus 1400 may be configured to perform one or more processes described herein, such as process 1100 of FIG. 11, process 1200 of FIG. 12, or a combination thereof. In some aspects, the apparatus 1400 and/or one or more components shown in FIG. 14 may include one or more components of the network node described in connection with FIG. 1 and FIG. 2. Additionally, or alternatively, one or more components shown in FIG. 14 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2. In some aspects, the reception component 1402 and/or the transmission component 1404 may include or may be included in a network interface. The network interface may be configured to obtain and/or output signals for the apparatus 1400 via one or more communications links, such as a backhaul link, a midhaul link, and/or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1404 may be co-located with the reception component 1402 in one or more transceivers.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The transmission component 1404 may transmit a configuration indicating a shared bandwidth allocation. The transmission component 1404 may transmit an uplink grant that indicates an uplink resource allocation. The reception component 1402 may receive data associated with an LCH in the uplink resource allocation, wherein the data associated with the LCH that is received in the uplink resource allocation occupies at least a portion of the shared bandwidth allocation.

The transmission component 1404 may transmit a configuration that indicates a first priority associated with a first LCH and indicates that the first LCH is allowed to upgrade data to a second LCH associated with a second priority that is higher than first priority. The transmission component 1404 may transmit an uplink grant that indicates an uplink resource allocation. The reception component 1402 may receive data associated with the second LCH in the uplink resource allocation, wherein the data associated with the second LCH that is received in the uplink resource allocation includes data that the first LCH upgraded to the second LCH in accordance with the configuration.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a UE, comprising: receiving a configuration indicating a shared bandwidth allocation; receiving an uplink grant that indicates an uplink resource allocation; and transmitting data associated with an LCH in the uplink resource allocation, wherein the data associated with the LCH that is transmitted in the uplink resource allocation occupies at least a portion of the shared bandwidth allocation.

Aspect 2: The method of Aspect 1, wherein the shared bandwidth allocation includes a first number of shared bandwidth tokens, and wherein the data associated with the LCH that occupies the portion of the shared bandwidth allocation uses a second number of shared bandwidth tokens that does not exceed the first number of shared bandwidth tokens.

Aspect 3: The method of any of Aspects 1-2, wherein the shared bandwidth allocation includes a first number of shared bandwidth tokens that is decremented by a second number of shared bandwidth tokens used by the data associated with the LCH that occupies the portion of the shared bandwidth allocation.

Aspect 4: The method of any of Aspects 1-3, wherein the configuration indicates the shared bandwidth allocation according to at least a PBR and a BSD.

Aspect 5: The method of Aspect 4, wherein the shared bandwidth allocation includes a set of shared bandwidth tokens that are generated at a rate associated with the PBR.

Aspect 6: The method of Aspect 5, wherein a maximum number of shared bandwidth tokens in the set of shared bandwidth tokens is a product of the PBR and the BSD.

Aspect 7: The method of any of Aspects 1-6, wherein the configuration indicates the shared bandwidth allocation according to a maximum number of bandwidth tokens in a sliding time window.

Aspect 8: The method of any of Aspects 1-7, wherein the data associated with the LCH that is transmitted in the uplink resource allocation occupies the portion of the shared bandwidth allocation in accordance with a delay requirement.

Aspect 9: The method of any of Aspects 1-8, further comprising: distributing, within the uplink resource allocation, the shared bandwidth allocation among LCHs in an LCH group that includes the LCH.

Aspect 10: The method of Aspect 9, wherein the shared bandwidth allocation is distributed among the LCHs in the LCH group according to information generated by an AI/ML model.

Aspect 11: The method of Aspect 9, wherein the LCH group is an LCH scheduling group that includes one or more LCHs associated with a scheduling policy.

Aspect 12: The method of any of Aspects 1-11, further comprising: receiving an updated configuration indicating a change to one or more parameters associated with the shared bandwidth allocation.

Aspect 13: A method of wireless communication performed by a UE, comprising: receiving a configuration that indicates a first priority associated with a first LCH and indicates that the first LCH is allowed to upgrade data to a second LCH associated with a second priority that is higher than first priority; receiving an uplink grant that indicates an uplink resource allocation; and transmitting data associated with the second LCH in the uplink resource allocation, wherein the data associated with the second LCH that is transmitted in the uplink resource allocation includes data that the first LCH upgraded to the second LCH in accordance with the configuration.

Aspect 14: The method of Aspect 13, wherein the configuration indicates a maximum amount of data that the first LCH is allowed to upgrade to the second LCH.

Aspect 15: The method of Aspect 14, wherein the maximum amount of data that the first LCH is allowed to upgrade to the second LCH is indicated according to a PBR and a BSD.

Aspect 16: The method of Aspect 15, wherein the maximum amount of data that the first LCH is allowed to upgrade to the second LCH increases at a rate associated with the PBR.

Aspect 17: The method of Aspect 15, wherein the maximum amount of data that the first LCH is allowed to upgrade to the second LCH is a product of the PBR and the BSD.

Aspect 18: The method of Aspect 14, wherein the configuration indicates a sliding time window associated with the maximum amount of data that the first LCH is allowed to upgrade to the second LCH.

Aspect 19: The method of Aspect 14, further comprising: receiving an updated configuration indicating a change to the maximum amount of data that the first LCH is allowed to upgrade to the second LCH.

Aspect 20: The method of any of Aspects 13-19, wherein the data is upgraded from the first LCH upgraded to the second LCH according to information generated by an AI/ML model.

Aspect 21: The method of any of Aspects 13-20, wherein a size of the data upgraded from the first LCH upgraded to the second LCH is determined according to information generated by an AI/ML model.

Aspect 22: A method of wireless communication performed by a network node, comprising: transmitting a configuration indicating a shared bandwidth allocation; transmitting an uplink grant that indicates an uplink resource allocation; and receiving data associated with an LCH in the uplink resource allocation, wherein the data associated with the LCH that is received in the uplink resource allocation occupies at least a portion of the shared bandwidth allocation.

Aspect 23: The method of Aspect 22, wherein the configuration indicates the shared bandwidth allocation according to a PBR and a BSD.

Aspect 24: The method of any of Aspects 22-23, wherein the configuration indicates the shared bandwidth allocation according to a maximum number of bandwidth tokens in a sliding time window.

Aspect 25: The method of any of Aspects 22-24, wherein the data associated with the LCH that is received in the uplink resource allocation occupies the portion of the shared bandwidth allocation in accordance with a delay requirement.

Aspect 26: The method of any of Aspects 22-25, wherein the shared bandwidth allocation is associated with an LCH scheduling group that includes one or more LCHs associated with a scheduling policy.

Aspect 27: The method of any of Aspects 22-26, further comprising: transmitting an updated configuration indicating a change to one or more parameters associated with the shared bandwidth allocation.

Aspect 28: A method of wireless communication performed by a network node, comprising: transmitting a configuration that indicates a first priority associated with a first LCH and indicates that the first LCH is allowed to upgrade data to a second LCH associated with a second priority that is higher than first priority; transmitting an uplink grant that indicates an uplink resource allocation; and receiving data associated with the second LCH in the uplink resource allocation, wherein the data associated with the second LCH that is received in the uplink resource allocation includes data that the first LCH upgraded to the second LCH in accordance with the configuration.

Aspect 29: The method of Aspect 28, wherein the configuration indicates a maximum amount of data that the first LCH is allowed to upgrade to the second LCH.

Aspect 30: The method of Aspect 29, wherein the maximum amount of data that the first LCH is allowed to upgrade to the second LCH is indicated according to a PBR and a BSD.

Aspect 31: The method of Aspect 29, wherein the configuration indicates a sliding time window associated with the maximum amount of data that the first LCH is allowed to upgrade to the second LCH.

Aspect 32: The method of Aspect 29, further comprising: transmitting an updated configuration indicating a change to the maximum amount of data that the first LCH is allowed to upgrade to the second LCH.

Aspect 33: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-32.

Aspect 34: An apparatus for wireless communication at a device, the apparatus comprising one or more memories and one or more processors coupled to the one or more memories, the one or more processors configured to cause the device to perform the method of one or more of Aspects 1-32.

Aspect 35: An apparatus for wireless communication, the apparatus comprising at least one means for performing the method of one or more of Aspects 1-32.

Aspect 36: A non-transitory computer-readable medium storing code for wireless communication, the code comprising instructions executable by one or more processors to perform the method of one or more of Aspects 1-32.

Aspect 37: A non-transitory computer-readable medium storing a set of instructions for wireless communication, the set of instructions comprising one or more instructions that, when executed by one or more processors of a device, cause the device to perform the method of one or more of Aspects 1-32.

Aspect 38: A device for wireless communication, the device comprising a processing system that includes one or more processors and one or more memories coupled with the one or more processors, the processing system configured to cause the device to perform the method of one or more of Aspects 1-32.

Aspect 39: An apparatus for wireless communication at a device, the apparatus comprising one or more memories and one or more processors coupled to the one or more memories, the one or more processors individually or collectively configured to cause the device to perform the method of one or more of Aspects 1-32.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, which, individually or in any combination, are operable to cause the apparatus to:
receive a configuration indicating a shared bandwidth allocation;
receive an uplink grant that indicates an uplink resource allocation; and
transmit data associated with a logical channel (LCH) in the uplink resource allocation, wherein the data associated with the LCH that is transmitted in the uplink resource allocation occupies at least a portion of the shared bandwidth allocation.

2. The apparatus of claim 1, wherein the shared bandwidth allocation includes a first number of shared bandwidth tokens, and wherein the data associated with the LCH that occupies the portion of the shared bandwidth allocation uses a second number of shared bandwidth tokens that does not exceed the first number of shared bandwidth tokens.

3. The apparatus of claim 1, wherein the shared bandwidth allocation includes a first number of shared bandwidth tokens that is decremented by a second number of shared bandwidth tokens used by the data associated with the LCH that occupies the portion of the shared bandwidth allocation.

4. The apparatus of claim 1, wherein the configuration indicates the shared bandwidth allocation according to at least a prioritized bit rate (PBR) and a bucket size duration (BSD) for a set of shared bandwidth tokens that are generated at a rate associated with the PBR.

5. The apparatus of claim 4, wherein a maximum number of shared bandwidth tokens in the set of shared bandwidth tokens is a product of the PBR and the BSD.

6. The apparatus of claim 1, wherein the configuration indicates the shared bandwidth allocation according to a maximum number of bandwidth tokens in a sliding time window.

7. The apparatus of claim 1, wherein the data associated with the LCH that is transmitted in the uplink resource allocation occupies the portion of the shared bandwidth allocation in accordance with a delay requirement.

8. The apparatus of claim 1, wherein the one or more processors are further individually or in any combination operable to cause the apparatus to:
distribute, within the uplink resource allocation, the shared bandwidth allocation among LCHs in an LCH group that includes the LCH.

9. The apparatus of claim 8, wherein the shared bandwidth allocation is distributed among the LCHs in the LCH group according to information generated by an artificial intelligence or machine learning model.

10. The apparatus of claim 8, wherein the LCH group is an LCH scheduling group that includes one or more LCHs associated with a scheduling policy.

11. The apparatus of claim 1, wherein the one or more processors are further individually or in any combination operable to cause the apparatus to:
receive an updated configuration indicating a change to one or more parameters associated with the shared bandwidth allocation.

12. An apparatus for wireless communication at a user equipment (UE), comprising:
one or more memories; and
one or more processors, coupled to the one or more memories, which, individually or in any combination, are operable to cause the apparatus to:
receive a configuration that indicates a first priority associated with a first logical channel (LCH) and indicates that the first LCH is allowed to upgrade data to a second LCH associated with a second priority that is higher than first priority;
receive an uplink grant that indicates an uplink resource allocation; and
transmit data associated with the second LCH in the uplink resource allocation, wherein the data associated with the second LCH that is transmitted in the uplink resource allocation includes data that the first LCH upgraded to the second LCH in accordance with the configuration.

13. The apparatus of claim 12, wherein the configuration indicates a maximum amount of data that the first LCH is allowed to upgrade to the second LCH.

14. The apparatus of claim 13, wherein the maximum amount of data that the first LCH is allowed to upgrade to the second LCH is indicated according to a prioritized bit rate (PBR) and a bucket size duration (BSD).

15. The apparatus of claim 14, wherein the maximum amount of data that the first LCH is allowed to upgrade to the second LCH increases at a rate associated with the PBR or is a product of the PBR and the BSD.

16. The apparatus of claim 13, wherein the configuration indicates a sliding time window associated with the maximum amount of data that the first LCH is allowed to upgrade to the second LCH.

17. The apparatus of claim 13, wherein the one or more processors are further individually or in any combination operable to cause the apparatus to:
receive an updated configuration indicating a change to the maximum amount of data that the first LCH is allowed to upgrade to the second LCH.

18. The apparatus of claim 12, wherein the data is upgraded from the first LCH upgraded to the second LCH according to information generated by an artificial intelligence or machine learning model.

19. The apparatus of claim 12, wherein a size of the data upgraded from the first LCH upgraded to the second LCH is determined according to information generated by an artificial intelligence or machine learning model.

20. An apparatus for wireless communication at a network node, comprising:
one or more memories; and
one or more processors, coupled to the one or more memories, which, individually or in any combination, are operable to cause the apparatus to:
transmit a configuration indicating a shared bandwidth allocation;
transmit an uplink grant that indicates an uplink resource allocation; and
receive data associated with a logical channel (LCH) in the uplink resource allocation, wherein the data associated with the LCH that is received in the uplink resource allocation occupies at least a portion of the shared bandwidth allocation.
